(19) United States
(12) Patent Application Publication
(10) Pub. No.: US 2006/0235776 A1
(43) Pub. Date: Oct. 19, 2006

(54) Method of Taxation and Tax Collection

(76) Inventor: Alf Temme, North Hollywood, CA (US)

Correspondence Address: KYLE W. ROST, 5490 AUTUMN CT., GREENWOOD VILLAGE, CO, 80111, US

(21) Appl. No.: 10/907,480

(22) Filed: Apr. 1, 2005

(51) Int. Cl. G06F 17/22

(52) U.S. Cl. 705/31

(57) ABSTRACT

Fund transfer transactions within an economy are monitored at a selected level, such as at entry into the banking system and exit from the banking system. Every transaction is processed at its exit and its entry points to the banking system by deducting from the transaction value an equal percentage at both exit and entry points. The bank collects data about substantially all transactions to show at least the tax nexus of a transacting party. Certain collected data can trigger special processing methods that cause deduction of tax at an alternate rate or direct some of the tax to a specially designated recipient. The bank transfers the collected tax to the bank's tax jurisdiction or to one or more tax jurisdictions that the collected data shows to have a tax nexus to one or more transacting parties.

### BACKGROUND OF THE INVENTION

1. Field of the Invention

The invention generally relates to financial practice and data processing. More specifically, the invention relates to automated financial arrangements, including accounting and tax preparation or submission. In particular, the invention relates to a system for reporting tax transactions and collecting taxes. This system is suitable for raising funds in amounts exceeding the needs of all U.S. taxing jurisdictions combined. A single collection process meets the combined needs of federal, state, county and local tax jurisdictions; or it can be used for a single jurisdiction or a combination of several jurisdictions.

The invention relates to a method of collecting tax revenue through automation and the elimination of accounting, paperwork and filing requirements for the general public. For each respective taxing jurisdiction, the method generates and delivers a revenue stream that nearly accurately reflects the economic activity within the jurisdiction. The needs of diverse jurisdictions are met, including neighborhood, city, county, special district, regional, state, and federal domains. In addition, legislated revenue shifts and voter directed revenue shifts are effected through changes in computer software commands. Security codes and protocols within such software can guard against fraud.

2. Description of Related Art Including Information Disclosed Under 37 CFR 1.97 and 1.98

Collecting revenue is necessary to fund governments at all levels, including national, regional and local levels. Most countries employ systems of taxation to supply revenue at each level of government. Often a separate tax collection system exists to fund each national, regional and local government jurisdiction. Each of these tax jurisdictions may have legislated into existence its own tax-collecting agency, complete with distinct laws, regulations, audit departments and enforcement methods.

In the United States the largest tax collecting system is the federal income tax, administered by the United States Treasury through the Internal Revenue Service (IRS). The first line of operation relies upon self-reporting by each taxpayer, whether individual, partnership, corporation, or other entity. Enforcement is carried out by a program of audits, backed up by informational reports of significant money transfers such as wages paid and securities sold. Thus, the individual taxpayer is held accountable at multiple levels. The taxpayer is required to make proper tax payments. In order to be able to make such payments, he must keep adequate records. Further, he must accurately calculate the amount due, and he must accurately report the sources of funds upon which he makes payments. All of these levels of accountability rest upon a basic precedent that the taxpayer must understand the tax laws and regulations sufficiently well to properly abide by all of the aforementioned requirements.

A substantial portion of the population lacks the required expertise to accurately perform these mandated duties. The laws, rules, regulations, and accounting practices that underlie the tax system are far too complex. Individual taxpayers and other small entities very likely lack the expertise to accurately carry out their first line responsibilities within the federal tax system. This problem has been long-standing, originating with growing complexity of the Internal Revenue Tax Code and compounded by the lack of an effective system for educating the taxpayer.

At the federal level, U.S. tax laws are among the most complex and difficult to understand of all laws. For many taxpayers, fully comprehending and applying the tax code is vastly difficult. These many taxpayers must obtain professional help or risk failing to comply with the law. The present Internal Revenue Code, tax regulations and rulings are complex and difficult to understand. Among tax professionals, few fully comprehend all parts of the tax law. It has been reported that even members of the United States Congress who claim to fully understand the Internal Revenue Code are not taken seriously by their colleagues. Consequently, this system of taxation easily exceeds the grasp of a substantial portion of the citizen taxpayers. The existing system creates significant difficulties both for the government and the citizens. Such a difficulty, centered upon one of government's most important and basic needs, creates an environment of economic uncertainty.

The clear, singular purpose of taxation is to fund governmental operations. However, the tax system often is distorted to favor political and social causes. Special interest groups and lobbyists work hard to change the tax system to achieve their own sponsored goals. Governments and political parties also use the tax system to achieve political goals. Depending upon current popular opinion, the strength of special interest campaigns, or the platform of a political party in office, tax systems are changed and manipulated to work for or against any chosen cause or industry. By way of example, recent history shows proposals for tax changes favoring or disfavoring energy development, environmental causes, big industry, foreign imports, or the economic groups that often are referred to as the rich or the poor.

Changing a technical scheme such as the tax laws fairly guarantees that a portion of the population will not understand how to accurately implement the change. Present tax laws are a product of years of changes, ensuring that a substantial portion of tax returns contain errors, despite the best efforts made by the taxpayer. The same government that creates an ever-changing tax scheme also enforces it against the taxpayers. Enforcement is an expensive task that burdens both the taxpayer and the government. Many people would consider it unconscionable for a government to create a needlessly complex tax scheme, place responsibility for its performance on the ordinary citizen, and then police the scheme; fully knowing that citizens will fail in the imposed task. Nevertheless, this is the present situation. The taxation system carries a high cost to the public. This cost can be quantified as a function of measurable factors. These include the number of tax jurisdictions, the number of people employed in the tax system, the size of the budget for annual administration of the tax system, and the estimated cost of the indirect burden placed on the national economy. In the United States alone there are approximately 30,000 tax collecting jurisdictions. Some follow the federal plan of taxing income, while others levy tax based upon real estate values, personal property values, or sales of goods. Substantially every tax system places the payment burden at the lowest possible level: on the individual citizen, on the individual business, on the property owner, on the employer, or on the merchant. Placing the payment burden at this level can be termed grass roots taxation.

The federal and all other tax systems impose an inherent direct social and economic burden. Much of this burden is through the size of the agencies employed in the tax business. For example, in recent years the U.S. government has employed about 98,000 people in the Internal Revenue Service. Recent annual budgets for the U.S. Internal Revenue Service have been about eight billion dollars, about half of which is earmarked for enforcement activities. Numerous other taxing agencies operate at regional levels, each with its own budget. The various state level tax agencies may operate through a statewide agency, operating under different names in different states such as a Department of Revenue in Colorado or Board of Equalization in California. Counties, municipalities, municipal districts, and special districts may operate through commissioners or a board of trustees. The total direct cost of salary and other operating expense of these roughly 30,000 taxing authorities adds a significant cost to the eight billion dollars spent by the Internal Revenue Service. The total direct burden imposed by taxing agencies for record keeping and tax preparation by individuals and businesses is enormous.

While direct costs are enormous, present tax systems sponsor and impose an even larger indirect cost that is paid by society and individual citizens. Typical indirect costs include record keeping and reporting by all of the individual taxpayers to the many related tax collecting entities. The related diversion of time, effort and money can be viewed as unproductive and of negative impact on the economy. At least an estimate of this negative impact can be quantified. The combined indirect costs of administrative burdens related to taxation at all levels of government have been estimated in several university studies to be between 6% and 12% of the gross national product (GNP). In dollar values, such numbers range from about five hundred billion dollars to over one trillion dollars in indirect costs.

Many people and businesses are employed indirectly as a result of taxation and as a result of artificial economic circumstances created by taxation related interests. These include indirect employment in printing tax forms, printing tax advice, printing books used in accounting and book keeping, producing the paper needed for all of these products, and entire industries of tax- driven activities and products. As a result, the U.S. economy contains countless jobs that might be viewed as wholly or partially unproductive outside of their subordinate roles in the tax system. These jobs are a product of tax-driven, economic or social engineering, or exist without non-tax economic justification. Employment based on the artificial constructs of a tax system, rather than on an inherent need, might be called artificial jobs.

Many artificial jobs exist primarily to moderate the economic impact of taxation on individuals and businesses. Typically, these jobs relate to tax accounting; tax filing services; creating and selling tax-reducing investment schemes; issuing and administering tax free bonds; creating and administering non-profit organizations; organizing and administering tax-favored businesses and activities; and creating and administering tax-favored personal activities and investment schemes.

Artificial jobs can be viewed as another type of social and economic burden because their performance has reasonable justification only as a part or result of a tax driven environment. The existing tax system diverts productive capacity away from otherwise potentially constructive tasks and potential leisure time. It redirects such capacity to otherwise non-productive, tax-related tasks and activities.

“Push-and-pull” tax incentives are another form of artificial economic activity that current tax systems encourage. Regional governments such as states, counties, and cities are known to offer tax incentives, known as “push-and-pull” incentives, to lure large business to more into the region. Such inducements can amount to millions of dollars in tax saving incentives to the new business. The region gaining the new business benefits from having more employed citizens and better-employed citizens. The region gaining the new business expects increased local business activity benefiting individuals at all levels, producing a commensurate increase in sales and use taxes, real estate taxes, and eventually an ability to tax the capital base of the new business, itself. Of course, the region losing the business suffers equivalent economic losses. Thus, tax-based incentives causing business to relocate are a cause of significant economic disruption for both individuals and businesses. In a variation, a region may drive away businesses by increasing the several forms of local taxation to a level that compares poorly to tax levels in a different region.

Some states have enacted laws that restrict or disallow the ability of cities within those states to offer push-and-pull tax incentives. When a business proposes to move headquarters from one city to another, the result can be a lawsuit if prohibited push-and-pull tax incentives appear to have been offered. In various cases the laws that seek to restrict businesses from moving their headquarters also hamper those businesses in their natural growth via consolidation from several smaller locations in several cities to a single larger location in one of the cities in which they already have a presence. These limitations placed on businesses and commerce can restrict trade.

These activities that exist in order to respond to taxation, rather than for a bona fide social or business need outside the tax industry, are part of the indirect cost of taxation. The indirect costs placed on the economy may be even greater than suggested in the university studies. Some estimates of indirect cost reach 10% to 16% of the GNP, which translates to a dollar range from about $900 billion to $1.5 trillion.

Regardless of what cost figure is accurate, the quantum value of indirect costs can be compared to the U.S. federal budget, which in the year 2003 stands near two trillion dollars. This federal budget amount has been equated to 21% of national income. The total of all combined taxes placed upon U.S. taxpayers is about 32% of national income, suggesting that the direct tax burden from all sources is about three trillion dollars. By comparison, the indirect monetary cost burden of collecting federal and all other taxes is on the order of one-third to one-half the overall direct tax burden; and from about one-half to three-fourths the amount of the federal budget, alone.

Clearly it would be desirable to reduce this underlying indirect cost, so that such resources could be used more beneficially or to meet needs not artificially created for supporting the tax systems currently in use.

While certain indirect costs of the present system of tax collection can be quantified, others cannot. These latter costs include the loss of personal privacy and the loss of economic freedom. Further, taxpayers have been known to suffer health and social burdens that are closely related to tax payment issues. For example, some develop physical or mental health problems related to taxation. If tax reports or payments are not made properly, the taxpayer can suffer legal and financial difficulties, such as civil or administrative fines and criminal penalties.

Another area of high cost is in loss of time available to legislatures to address society's needs. Present tax systems divert this function of governments at all levels. Legislatures at all levels of government spend well over 50% of their time on discussions relating to taxation. The creation and implementation of a single system for supplying all required funding for all levels of government might free a vast portion of legislative time for more beneficial purposes.

Tax collecting agencies in the United States are well aware that the tax system imposes difficulties that lead to substantial non-compliance by the public. Notably, some citizens view the U.S. federal scheme as being unrealistic, as asking for conduct contrary to the self-preservation and self-interest components of human nature. Asking the individual to self-report his income and pay accordingly can place the taxpayer on the classic horns of a dilemma, balancing his personal financial health and well being against the financial obligation of the tax system. This system inherently urges the taxpayer to seek the legal limits in his reports and payments. Likely there are instances where the legal limits are exceeded. Tax collecting agencies acknowledge this problem and have coined the term, “tax gap,” to describe the difference between true tax liability and the amount voluntarily paid. In 1990, the IRS estimated that the tax gap for 1992 would be between $110 billion and $127 billion. The existence of the tax gap, or at least the government's suspicion that it exists, casts every taxpayer in a shadow of suspicion.

Taxpayers understand that their own government views them with this suspicion and distrust. Certainly some taxpayers harbor a reciprocal distrust toward the government. Recent history within the United States has produced significant examples of open confrontations between government agencies and groups of U.S. citizens who profess to distrust the government. Certainly the tax laws are not the sole cause of such distrust, and certainly no one solution can reverse all causes for distrust. Yet, it would seem that eliminating the pervasive conflict-of-interest between the individual citizen's self-interest and an unrealistic tax system would be a large step in the right direction.

It would be desirable to eliminate the social, political, and economic burden of the present tax system by implementing an alternative system that operates without substantial direct tax burden on the grass-roots taxpayer and with a vastly reduced economic burden on the country as a whole.

The above discussion of problems inherent in existing systems of taxation has referred to practices in the United States. However, the noted problems are not confined to any one country. Any political or economic system can benefit by instituting tax laws, rules and regulations that burden the public as little as possible. Further, a non-burdening tax system promotes economic efficiency and greater personal security. Such a system enables citizens to deal with each other and with their government with minimal uncertainty and lower transaction cost in time and money. Improving the flexibility and collection efficiency of a tax system, while reducing the burden on the citizen, can benefit governments worldwide.

The mission statement for the I.R.S. provides a useful standard for deciding whether the present U.S. tax system, as well as the system in any other nation, is adequate and might be considered successful. According to the U.S. Government Manual, 1992/1993, the official mission of the Internal Revenue Service is to collect the proper amount of tax revenue at the least cost to the public and in a manner that warrants the highest degree of public confidence in the Service's integrity. Any taxation authority seeking to meet those mission goals should consider direct costs, indirect costs, social burdens, and economic burdens that have been discussed. At present, the cost to the public exceeds any reasonable level.

It would be desirable to create a system of taxation that operates with less cost to the public and, thus, that better meets the reasonable parameters suggested by the U.S. Internal Revenue Service's own mission statement.

For these reasons and many others, it would be desirable to have a tax system that is less burdensome than one applied at the grass roots level. Many government officials, politicians and tax reform movements and groups have sought such a system. The U.S. Congress has considered proposals for simplified tax systems via a flat tax, a national sales tax, and a value added tax, among many others. Some of these proposals appear adequate as revenue raising techniques. However, the fundamental need to raise adequate revenue for government operations seems inseparable from imposition of political and social agendas. The present tax system and the various proposed alternate systems offer little hope for substantial reduction in the costs and burdens of collecting income tax. An overview and details of some major proposals for improvements to or replacement of our current taxation system follows.

A flat income tax might set a single tax rate of about 20-25% on all income, without special incentives and exemptions. This proposed system would eliminate much of the income tax code and would simplify filing individual income tax returns. While helpful to the ordinary citizen who is not a tax specialist, it still requires record keeping to track total income. Likely the government would continue to audit the individual citizen to maintain honesty and discover mistakes in the filed tax returns. In addition, this proposal simplifies only the federal tax system, while leaving the remainder of the 30,000 U.S. tax authorities unchanged. Special interest groups and many politicians dislike this proposal. Its simplicity eliminates the power to practice social and political engineering through the shifting of tax burdens. In addition, the flat tax could encourage a larger tax gap by creating an immediate income benefit of 20% to 25% to those who under-report income.

The proposal for a national sales taxwould add a point-of-sale tax of about 15-20% on the cost of every purchase. Such a system would decrease the present need for a federal tax collecting agency and could save billions of dollars in the federal budget. It would eliminate the filing of individual tax returns from citizens who are not involved in retail trade.

This result would benefit a major part of the population. However, retail businesses would administer collection of the sales tax. Most states already have a sales tax in place and now would merely increase the collected percentage by the amount of the federal sales tax. The tax-collecting burden would be an expansion of an existing system rather than a new administrative burden. The retail merchant merely would add the percentage of the national sales tax to the state sales tax that already is collected.

Problems with the national sales tax include honesty in payment and collection, as well as political and social objections. Retail customers have been known to take substantial steps to avoid current sales taxes. Some offer to pay cash in a record-free, tax-free purchase. Others order by mail from another jurisdiction to avoid tax. A substantial increase in the sales tax rate could encourage evasive measures and contribute to an off-the-books economy. A political and social objection is that people with lower income might have to spend every dollar of income, thus paying tax on 100% of income. Those with higher income might spend proportionately less of total income, thus avoiding present taxation on the unspent balance.

A value added tax is paid on the value or sales price of goods at each change of hands. For example, tax is imposed on the sale of raw material from supplier to manufacturer, again from manufacturer to wholesaler, again from wholesaler to retailer, and finally from retailer to consumer. At each stage, the seller collects a tax on the sale, while receiving credit for the corresponding tax he paid upon earlier purchasing the goods.

The value added tax is cumbersome and requires much administration, but tax cheating and tax avoidance are highly controlled by the extensive paper-trail documentation between businesses. This system is used in Europe as an alternative to sales tax, but in addition to income tax. If it were used solely as a replacement for income tax, the tax rate added to the cost of goods could be expected to be substantially higher than the 20% or more levied by many European countries. Such a high rate of tax would create tax increment percentages between businesses that would be attractive to circumvent.

While the high cost to the public is an important problem with the present federal tax system, another significant problem is in the ever-fluctuating imbalances between collections and spending needs with the existing taxation methods. An imbalance easily can occur between the revenue collected versus what is needed to fund government operations. On the collection side of the equation, the amount of revenue collected through current taxation is keyed to the level of individual and business net income. When gross income changes just slightly, the change in net income is dramatically greater. As a result, during economic boom times, a large excess of revenue often will result. However, during recessions there is often a dramatic shortfall. Such a result is exactly the opposite of what is desirable to enable a government to promote public good through managing the economy.

When the economy is in decline, governments at all levels can benefit their citizens by increasing public spending instead of decreasing it. Infusing an increased amount of money into the economy can reduce hardships and rekindle growth. This kind of economic thinking follows the theories of John Maynard Keynes and was adopted by the Roosevelt administration to lift the country out of the Great Depression through government spending for work and welfare programs. While early levels of increased spending for work and welfare programs alleviated a degree of hardships of the Great Depression, ultimately the more massive military spending for World War Two quickly ended the Great Depression.

However, with a tax system that collects in proportion to net income, the government sees less tax revenue in a declining economy, resulting in a tendency for government to economize, cut services, reduce the government work force, and simultaneously increase tax rates in an effort to balance its budget. The result is additional economic decline due to such government effected economizing efforts coupled with increased tax rates.

On the other hand, during economic boom times a government may find it easy to expand services and spend freely with its increased revenues. An increased number of social benefits may follow, even though such programs are likely to be less needed in economic boom times. It is in these economic boom times that governments are most likely inclined to cut tax rates and thereby apply an unnecessary stimulus to an already prosperous economy.

On the spending side of the equation, the government attempts to live within a budget based upon expected revenues. However, the government operates in a world arena where the unexpected is rather the rule than the exception. For example, wars, disruption of critical resources, and disasters can occur anywhere in the world. Any such unanticipated event may require a prompt and costly response. Because such events are unplanned, it is fairly guaranteed with existing taxation laws and practices that such events will disrupt the established balance between tax revenues and government budgets.

Under taxation practices currently employed, the stream of tax revenue is largely derived from individual personal income and corporate profits. Ironically, the size of the resulting stream of tax revenue is diametrically opposite to the spending needs of governments through fluctuating economic cycles. In a declining economic cycle, governments should infuse an increased amount of money into the economy to stimulate economic activity and restore prosperity. Yet during an economic down cycle, revenues are in sharp decline; and governments feel compelled to tighten their belts, downsize, and pair expenditures to meet declining revenues realities so as to balance their budgets. That then fosters a cycle of greater economic decline, producing a yet smaller stream of tax revenues. Ideally in such economic downturns, a tax system should enable governments to increase spending or governments should spend in excess of the tax derived revenue stream.

Conversely, when an economy is in a boom cycle, current taxation practices produce a revenue stream that exceeds government spending needs, producing a budget surplus. Conservative politicians often respond to surplus by reducing tax rates to gain favor with their constituents. On the other hand, liberal politicians often respond with welfare and subsidy programs to consume the revenue surplus. Both responses are well-intentioned measures that result in economic mistakes. Both overburden the economy and lead to over-demand and inflation. A better approach is to place tax revenue surpluses in reserve to cover inevitable shortfalls on the other side of the economic cycle.

Thus, it would be desirable to have a comprehensive taxation system that would create a revenue stream in excess of what is needed to meet budget demand and the government's spending needs. A regular surplus, kept in reserve, would enable governments to respond quickly and appropriately to a crisis or to economic fluctuations.

Similarly, it would be desirable to create a taxation system that can collect on a real-time basis. Should a sudden, exceptionally costly need arise, then a government employing such new taxation system could begin collecting tax at an increased level almost immediately. It would not be necessary to wait until the next tax year's annual collection ritual, in which the citizen taxpayers must be supplied with new tax forms, rules and tax rate schedules.

A second internal problem in existing tax systems is susceptibility to political manipulation. Politicians are able to redistribute the tax burden among various categories of taxpayers. Whether rich or poor, few taxpayers believe their own tax burden is fair and proper. Tax burdens can be redistributed through political action. Special interests work through lobbying groups and political parties to promote their own views of taxation to the lawmakers. The result is a continual realignment of the tax burden, potentially favoring one group at the expense of another in response to special interest pressures. Such realignments create economic uncertainty and contribute to an unstable and unpredictable economic environment that hampers long-term planning for businesses and individual citizens, alike.

Long-term planning is a vital ingredient for sound economic growth. Many taxpayers see ongoing unfairness in the current tax allocation system. Thus, it would be desirable to have a comprehensive tax system that collects tax in a manner that is less prone to favor selected taxpayers according to the efforts of special interest lobbyists they employ.

While certain problems in a tax system can be identified as cold-cut accounting issues or economic issues, another equally important type of problem is an issue of national character or moral strength. A tax law or any other law should not tempt and debase the citizen's moral character. An aspect of such concerns underlies the Fifth Amendment to the Constitution of the United States. Yet, the tax self-reporting collection method applicable to each individual and business challenges the taxpayer's knowledge, intelligence, ethics and honesty on a frequent basis.

Surveys of honesty in tax reporting by individuals and businesses show that a large percentage of them acknowledge a lack of honesty in tax reporting. The taxpayer may see a sizeable reward by under-reporting and under-payment. The self-reporting system creates a powerful temptation for dishonesty at the grass roots level, where monitoring and enforcement is most costly and difficult. Present taxation schemes may contribute significantly to a reduction in ethics, honesty, and national character among the general population.

Accordingly, it would be desirable to have a comprehensive tax system that does not ask the individual taxpayer to self-report and tempt him with a financial reward for dishonesty.

A related problem in the existing tax system is that the small taxpayer bears a disproportionate burden of compliance. This burden falls especially hard on the individual and especially on the young, the self-employed, the small business, and the start-up business. Such small taxpayers bear the full impact of complying with tax laws, regulations, and record keeping. Yet, these small taxpayers are most likely to suffer from inexperience and lack of resources to hire professionals for accounting and tax filing requirements. Large or well- established businesses are better able to comply, aided by tax professionals and longer experience in complying with the heavy accounting burden. A tax system that burdens and discourages individuals and small businesses with heavy compliance requirements is short sighted and discourages new small business upstarts that are a vital component of a vibrant national economy.

It would be desirable to have a comprehensive tax system that would not burden the small taxpayer with reporting and compliance. A function of government should be to facilitate small business upstarts, not discourage them with burdensome paperwork and record keeping requirements.

To achieve the foregoing and other objectives and in accordance with the purpose of the present invention, as embodied and broadly described herein, the method of taxation and collection of this invention may comprise the following:

### BRIEF SUMMARY OF THE INVENTION

Against the described background, it is therefore a general object of the invention to create a tax system having the capability to combine or replace many or all of the different tax systems at federal, state, and local levels of government. Such a system may be suitable and beneficial in countries other than the United States as well.

An important object is to create a single and simple form of tax that is collected by an automated system, resulting in reduced collection expenses and reduced or eliminated burdens on the grass roots taxpayers, small business taxpayers, and on larger enterprises as well.

A specific objective is to create a tax system that collects on a basis other than an income percentage, thus eliminating the temptation for the individual to circumvent the tax.

Another specific objective is to create a tax system with an automatic compliance trail. Such a system eliminates record keeping requirements for individuals and businesses alike.

Still another objective is to eliminate problems of uneven revenues that are dependent upon income and subject to political manipulation. An improved tax system would produce total revenue that exceeds the revenue needed in both boom and bust economies. Further, the level of surplus revenue can be monitored and tax rates adjusted up or down as required to maintain the surplus within a targeted range. Such a system would allow a surplus for long- term benefits, such as to gradually reduce and ultimately eliminate the national debt. Similarly, a surplus could be used to restructure and bolster the social security system into a reliable old age pension system.

According to the invention, the method of taxation is suited for use at any level from a local tax jurisdiction to a national tax jurisdiction. The method is applied to substantially all money transfer transactions within the tax jurisdiction. The applicable tax jurisdiction performs a first step in the method by determining a suitable rate for taxation. This is done by periodically establishing a budget for all tax jurisdictions having nexus to any given political geographic area. The jurisdiction also projects a possible gross value of monitorable money transfer transactions having a nexus to the tax jurisdiction for the budget period. By comparing the budget to the projected gross value of transactions, the jurisdiction can set a rate of taxation. This rate should be at least the percentage of the projected gross value of transactions needed to produce the budget. The selected percentage can be increased to produce a surplus or to compensate for anticipated exceptions to uniform tax collection from the gross value of transactions. The tax jurisdiction collects the tax by deducting the set tax rate percentage from the value of substantially every monitorable money transfer transactions having a nexus to the tax jurisdiction and then distributing the total tax collected according to the legislated budget projections of the included tax jurisdictions.

The method can be applied to either a partial budget for the tax jurisdiction or the entire budget. Thus, this method can be the sole method of tax collection or merely part of a larger scheme collecting tax by a plurality of methods. Also, the method can be employed for any desired time period.

Monitorable money transfer transactions generally are those occurring at a bank, such as when a bank receives and processes a money transaction of any kind. Monitorable transactions are inclusive of a deposit of cash into a bank, the deposit of a check into a bank, cashing a check at a bank, an electronic transfer of funds into a bank, and the deposit of a negotiable instrument into a bank. For the purpose of this invention banks are the preferred entities to collect the tax by deducting it from the value of every processed transaction. Banks both collect the tax and distribute it to the tax jurisdiction.

In another aspect, a tax jurisdiction obtains tax revenue by, first, determining a rate for taxation. A suitable rate is a percentage of the monetary value of money movement transactions having nexus to the tax jurisdiction. Second, the jurisdiction collects a tax on the value of a money movement at the determined rate for taxation during bank processing of the money movement. The bank can collect the tax by deducting it from each transaction during processing. Third, collected tax is distributed to the tax jurisdiction.

A primary method of collecting the tax is for a bank within the tax jurisdiction to deduct the tax from transactions it processes. Another method of collecting the tax is for any bank having a nexus to the tax jurisdiction to deduct the tax from transactions it processes, regardless of whether the processing bank is within the tax jurisdiction. As a part of the tax collection process, a bank can collect data indicative of the tax jurisdiction of a party to the money movement transaction. Then, the bank can respond to the collected data by distributing at least a portion of the tax to the tax jurisdiction of the party having nexus to such tax jurisdiction.

Optionally, the method can allow a party to a transaction to direct or designate a portion of the deducted tax to a preferred or identified recipient, such as for donation by the party to the money movement to the recipient. The bank can respond to the data by distributing at least a portion of the tax to the preferred recipient.

As another optional step, a bank can collect data from a party to indicate special handling of the money movement and respond to the data by handling the money movement according to the indicated special handling.

Therefore, a method of collection is carried out by monitoring substantially all fund transfer transactions within a tax jurisdiction. Both outflow and inflow can be monitored and in the simplest form of this invention a 5% tax can be levied on all inflow funds of any money transaction. An alternative possibility is to deduct a small percentage, such as 2.5% from the outflow side of a money transfer transaction and another 2.5% from the inflow side. The deducted percentages can be paid to tax jurisdictions by electronic transfer. A single tax jurisdiction at state level could receive all taxes collected within a state and could distribute the collected taxes to all other lower tax jurisdictions having nexus to the revenue collected within that state. The tax jurisdictions at each state level may disburse a standardized percentage to the federal government tax jurisdiction, for example in the form of the IRS. Paying the taxes to the various other levels of government is made possible by initially coding each transaction to show the tax jurisdiction of the outflow side of each transfer transaction and coding the transaction once more to show the inflow tax jurisdiction.

The accompanying drawings, which are incorporated in and form a part of the specification illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a flow chart showing establishment and general operation of the money movement tax system.

FIG. 2 is a schematic view of a negotiable instrument having an area for entry of special handling codes for both outflow and inflow jurisdictions.

FIG. 3 is a flow chart showing processing of money movement transactions for tax collection.

FIG. 4 is a flow chart showing the tax distribution scheme for the tax system.

### DETAILED DESCRIPTION OF THE INVENTION

The invention is a system of processing for collecting tax on money movements. This system, which will be referred to as a money movement tax system or a money transfer transaction tax system, is a method of government revenue creation that can be applied to benefit governments at all levels. A general goal is to allow government to conduct its tax collection business in such a way that will provide adequate funding with revenue at all levels of government at all times. Tax is collected through an economical, computer-automated revenue stream. The collection is based upon value of money or fund movements. By keying tax collection to the transactional function of money itself, governments can adjust the size of the collected share without redrafting tax codes as commonly required with existing practices. Thus, when a change is made in the size of the collected share, citizens and businesses have no substantial re-education requirement apart from understanding the new rate of collection.

For purposes of this disclosure, except as specifically otherwise stated herein, the following terms will have the indicated meanings. The term, “bank,” will refer to a business establishment in which money is kept for saving or commercial purposes or is invested, supplied for loans, or exchanged. The terms, “money movement” or “money transfer transaction” and the like will refer to inflow or outflow of money or financial instruments, whether or not negotiable, with respect to a bank or such other entity further identified as an equivalent to a bank or as a suitable node of a financial network where the money movement tax may be applied. The term, “money,” refers to a commodity legally established as an exchangeable equivalent of all other commodities and is used as a measure of their comparative values on the market. Similarly, “money” refers to the official currency, coins, and negotiable paper notes issued by a government. Further, “money” refers to assets and property considered in terms of monetary value, thus including the monetary value of an account or financial instrument, including data indicative of monetary value.

In its simplest form, the money movement tax system requires that substantially all money movements within a tax jurisdiction be monitored at specified levels. Money movements are most effectively monitored at the point where they and enter a banking system. The United States maintains a system of Federal Reserve banks forming the backbone of a banking system. Numerous other banks operate throughout the country and are variously associated with each other and the Federal Reserve System to constitute a broad based banking system. This association includes systems of correspondent banks and systems whereby checks are cashed, cleared and routed to their home banks for debit from the drawer's account. Other associations are necessary for a bank to participate in electronic funds transfer transactions. Thus, although the types of associations between banks vary widely, the banking system provides a reliable, regulated, examined network of financial institutions at the heart of the national economy. Central banks and well-organized banking systems are found in almost every modern economy and are a vital ingredient of a well functioning government jurisdiction.

Almost every money movement eventually involves the services of a bank or bank equivalent entity. This involvement results from the need to process checks or make electronic fund transfers. Even if a private party cashes a check outside the banking network, the check eventually passes through the banking system in order to have its value drawn from the drawer's checking account or deposited to a recipient's account. Cash transactions often result in a cash deposit into a bank, if for no other purpose than safekeeping. Banks are monitorable way stations in the national economy because of their role in processing private and commercial transactions of any type. These transactions are monitorable because the banking system is a nationwide processing network and is substantially unavoidable when any significant business is transacted.

The tax system of this invention effectively collects a preselected, variable and determinable percentage from the value of substantially every money movement transaction within an economy, whether national, regional, or local. The preferred implementation collects such a percentage at two points. The first, as an example, is where the money leaves a bank of the paying party of the funds. The second, as an example, is where the money reaches the bank of the receiving party. The two most convenient reference points are when money leaves an account and when money is received, such as when funds are deposited into a customer account, such as when a check or other instrument is presented for payment. For purposes of example and not limitation, each of the two preselected percentages will be 2.5%.

With electronic transfers, the recipient's bank that receives transferred funds will deduct both preselected percentages, i.e., 5%, and will credit 95% of the transaction value to the recipient of the transferred funds. The bank receiving the funds pays one of the preselected percentages, such as one-half or 2.5% of the deducted tax to a tax jurisdiction or tax-collecting agency in the state or other locality where the funds were received. For purposes of example and not limitation, the applicable locality will be considered to be a state; and such a state tax-collecting agency may be referred to as a State Revenue Disbursement Authority (SRDA).

The bank on which the funds are drawn credits the bank of the recipient of the funds with 97.5% of the face value of the transaction. The bank on which the funds are drawn pays the remaining 2.5% tax to its local branch of its State Revenue Disbursement Authority (SRDA). If the bank of the recipient is outside the jurisdiction of the United States, the payer's bank credits the recipient's bank with 95% of the face value of the payment and pays a full 5% to its local branch of a SRDA. If the bank of the person paying the funds is outside the jurisdiction of the United States, the bank of the recipient of the funds in the United States will pay the total 5% deducted to its local SRDA.

This method of tax collection is applied in a new way, using existing data processing equipment and banking channels, but applying the tax to the total flow of money. Where present income tax system collects a single bulk payment gauged to net income, the new method collects many smaller payments gauged to the circulation of money. In effect, this money movement tax system may be referred to as a transaction tax or gross receipts tax on any movement of money, although at a practical level it is a tax on funds leaving and entering the banking system. Such a form of tax appears to be fully authorized by the United States Constitution as an excise tax, levied on monetary transactions. Thus, the tax is applied to any form of economic activity involving movement of money in a situation that lends itself to monitoring. Legislatures can implement this system on a jurisdiction-by-jurisdiction basis, with or without statewide or national support.

The money movement tax system has multiple stages and component parts. The implementation of a system and method of raising revenue for all levels of government involves administrative processing steps applied to the existing economic and banking infrastructure. Because this method is conceived to serve governments and taxing jurisdictions, its implementation requires enabling legislation. There are numerous difficulties in predicting the outcome of a legislative effort, due to the mixture of social, political, legal, economic and other forces at work in a legislative body. Consequently, some aspects of this disclosure may be viewed as advisory or the subject matter of opinion rather than factual or mandatory. The intent is to provide the best guidance for implementing the system. As a particular example, throughout this disclosure the combined tax rate is suggested to be 5% of each transaction. This percentage should be understood to be advisory, based upon recent data, and may be revised without departing from the invention.

Theoretically, the money movement tax could be applied when money changes hands for any economic reason. In practical operation, the tax is applied to every deposit and withdrawal, without necessary regard for economic reason or the presence of an associated transaction behind it. No type of transaction necessarily is exempt, although the collection points or nodes in the economy where the tax is extracted are best located with banks or bank equivalents, rather than with merchants. The associated or background event that triggers the tax might be payment for goods or services, although it is the transfer of money rather than the transfer of goods and services that is taxed. From another viewpoint, the associated or background event is gross receipts by any business entity, whether proprietorship, partnership, company, or corporation, regardless of how such receipts are acquired.

Each tax collection point or node in the banking system collects the tax at a predetermined rate or magnitude, such as 5% on each processed money transfer transaction. The amount of the tax is disbursed to the various levels of government having a nexus to collected funds. The legislative authority at each level determines the needs of the level, such as by a typical budgeting process. The tax rate is set according to what percent of the projected value of transactions is needed to reach the desired budget level. The budget requirements of all levels of government having nexus to a collection node are combined to determine the rate of collection at each node.

A desirable embodiment of this invention sets a nationwide standard tax collection rate. The selected rate should be sufficient to satisfy and exceed the combined budgeted revenue needs of all included jurisdictions. Thus, budget needs are combined for all local and higher jurisdictions in all states and at all combined levels of government having nexus to the tax. The resulting percentage of tax should be sufficient to exceed the combined revenue needs of most jurisdictions. Each SRDA may acquire excess undistributed revenue.

These undistributed excess funds can be held in reserve. Optionally, the funds can be credited to the lowest government jurisdiction having nexus to the funds collected. There, excess funds can be used for local projects or they may be refunded proportionally to the accounts from which the taxes were deducted.

In the United States today, over 99% of the value of money moved is done by electronic transaction. The majority of cash transactions involve currency received by a merchant and then deposited into a bank. As a result, these merchant deposits also are subject to an electronic transaction into the merchant's account.

The electronic capturing of these transactions is done through banks, bank clearinghouses, wire transfer services, stock and commodity clearinghouses, Internet financial clearinghouses, and credit card processing services. All of these agencies are suitable for selection as nodes of the tax collection system. Thus, these agencies can be included within the umbrella term, “banks,” and their activities can be included in the umbrella term, “banking transactions.” Suitable electronic money transaction facilities largely are in place in the banking system and are presently recording fund transactions. The implementation of the tax system involves additional software implementation and electronic processing steps, but extensive new facilities are not required.

The money movement tax system can function within such existing structure by requiring an electronic deduction from each banking or money transfer transaction. Each of the various levels of government constitutes a tax jurisdiction. Smaller or local tax jurisdictions will fall within one or more larger or regional tax jurisdictions. These smaller tax jurisdictions will be referred to as included jurisdictions. The tax collection system can distribute the collected revenue with electronic efficiency to the various levels of tax jurisdictions, from high-level regional jurisdictions to low-level included jurisdictions, which may exist within or overlap the area in which the taxes are collected.

According to one embodiment of a method of taxation and distribution, each tax jurisdiction receives a preselected percentage of each transaction that takes place with nexus to its local area. Thus, a single local area may fall within a plurality of tax jurisdictions, from low level to high level. A transaction that takes place within the local area will be taxed suitably at a cumulative percentage corresponding to the sum of the tax requirements of each of those jurisdictions that include the local area.

According to another embodiment, nexus data is collected about each transaction, such as the identity and residence or business location of each party to the transaction. This data may be fully pre-established as in credit card transactions or partially pre-established as in check transactions. Such data can be used to determine a tax nexus for transactions processed outside the parties' home area. It may be desirable to credit a distant tax jurisdiction for all or part of the tax, especially if the distant jurisdiction lacks a bank or other node, or the transaction is large. Each tax jurisdiction receives a weighted percentage of the total attributed to its area or having a nexus, as shown by data gathered about each transaction. This method allows an area to benefit from its citizens' economic activity, regardless of whether a transaction takes place within the citizens' home area or within the tax jurisdiction.

Weighting measures the economic proximity of a taxpayer to each of the several levels of government overlying an area. The area can be determined by any distinguishing characteristic. For example, a geographical area can be a physically bounded tract of land such as a subdivision, school district, city, county, township, state, or country. Alternatively, a virtual area can be described by a variety of other distinguishing characteristics. Several examples of alternative distinguishing characteristics are telephone area code, telephone exchange, or postal code. The area could have associated with it a unique identifier that can be recorded as a tag on transactions by that area's taxpayer citizens such as a Global Positioning System (GPS) locator code.

Using postal codes as an example, weighting could be done by an automated computer system in each bank. Such a system can collect the postal code of each bank customer who either holds an account at the bank or otherwise transacts business with the bank. Each transaction handled by the bank is tagged according to the postal code of the transacting party. Then, the computer can deduct a tax and can attribute the deducted tax to the several levels of government having jurisdiction over the area comprised by the postal code of the transaction. Each of the tax jurisdictions will receive a proportional share of revenue from the tax on monies transferred into an account tagged to that postal code area.

A postal code area may be located in multiple tax jurisdictions of the same level of government, such as multiple school districts, which may be termed competing jurisdictions. The collected tax revenue may be allocated between the multiple competing jurisdictions according to the percentage of population located in each of the competing tax jurisdictions.

In this second embodiment, each tax area is not dependent upon having a proportionate number or size of banking institutions within it. This method accommodates the economic reality that certain tax areas may have a disproportionately large or small number of banks within it. Certain tax areas may process a disproportionate number or size of transactions by visiting taxpayers. Regardless of these disproportionate factors, each tax area will receive tax revenue from the monies transacted by its own taxpayers through any banking institution. A party to a transaction may ensure his tax area will benefit by providing the appropriate area tag when a transaction takes place. The tag may correspond either to the home area or the business area of the party. One suitable way to tag a transaction is by having nexus information printed on the party's bank check, such as by a machine-readable address code or a barcode containing the requisite information.

In a further adaptation of available technology, the method of tagging tax areas can be done by global positioning satellite or equivalent absolute positioning technology. Positional map coordinates can exactly determine the home or business location of an account holder or other transacting party. A computer referencing a database of geographical and tax jurisdiction information can identify each applicable tax jurisdiction within which a transaction party resides or does business.

Money movements in commerce consist of both amounts paid and amounts received. The money movement tax system can be applied in a consistent manner to either side of such transactions or proportionately to both. The preferred method is to tax every movement of funds at half the total tax rate at both sides of the transaction. For example, a total tax transaction may include deducting 2.5% of the total money movement at the recipient side and 2.5% at the paying side of the transaction for an overall 5% deduction from the total money movement transaction. Each transaction should be taxed no more than the combined 5% tax rate. Half of the tax should be applied at the point where the flow of funds reaches the recipient, and half should be applied where the funds leave the paying side of the money transfer.

Sequential processing steps that may involve moving money through a series of banks should not result in multiple deductions of tax. The data accompanying a transaction can include the identity of the bank that applied the tax so that subsequent processors will know the tax already has been taken. In case the recipient of the funds is outside the jurisdiction of the United States, the bank from which the funds are paid can credit the foreign bank with only 95% of the face value of the transaction and will pay the full deducted 5% to its local SRDA. In case the paying party is outside the jurisdiction of the United States, the bank of the recipient of the funds credits the recipient's account with 95% of the funds and pays the deducted 5% tax to its local SRDA.

Government revenue generated by a 5% tax on money movement in the United States is projected to be far greater than the sum of all current taxes and other fees that are collected at all jurisdictional levels combined. A consideration of business practice demonstrates the magnitude of collectable revenues. An average mix of large and small businesses has an average net income on the order of 5% to 8% of total receipts, after the costs and write-offs have been deducted from gross receipts. A 30% conventional tax on this income of 5% to 8% of total receipts would yield tax revenue equivalent to about 1.5% to 2.4% of gross receipts of the business. As evident by comparison, a 5% transaction tax on gross receipts would produce two or more times the current tax revenues generated by current income tax schemes and would easily cover the combined revenue requirements at all levels of government in the United States. Supplementing this benefit, this money transfer tax system will save most individuals the aggravation of dealing with tax forms and complex tax legislation. An estimated 10% to 16% of the national work force will be freed of tax-related duties to pursue more productive activities that can raise the standard of living.

Taxing authorities in the United States in 2001 raised a cumulative 3 to 4 trillion dollars, while the gross domestic product or gross national product was around 8 trillion dollars. Since the current conventional taxation systems are primarily based on income, the amount of tax revenue would be limited by the total of net income generated by individuals and companies combined. That will prove to be a fatal flaw of all current forms of taxation and will render the flow of revenue completely unpredictable and disruptive to managing budgets of all jurisdictions involved.

The revenue raising ability of the fund transfer tax system can be best appreciated from the perspective that this tax system is not limited by income. Similarly, it is not limited as a sales tax or point-of-sale tax that is linked to the end consumption of goods. Rather, this tax collection system is applied to substantially every movement of money to or from any person or entity, without any necessity for a related transaction involving products or services. It may be viewed as a tax applied against the monetary magnitude of gross receipts.

In perspective, if all businesses in a certain tax jurisdiction have an average net taxable income that is 5% of their gross receipts, and the tax rate on that 5% net taxable income is an average of 30%, then the income tax revenue will be 30% of 5% or 1.5% of the combined gross receipts of the businesses within such tax jurisdiction. If these same businesses have a bad year such that their gross receipts drop by 10% and net income drops to 1% of gross receipts, and if the tax rate remains at 30% of net income (in real life the tax rate drops because of progressive taxation schemes); then income tax revenue drops to 30% of 1% of gross receipts, which amounts to 0.3% or less of gross receipts. That is a devastating drop of almost 89% in tax revenue for the jurisdictions having nexus to the taxes collected from these businesses.

In the perspective of this invention, the tax system is applied against a financial total flow of money that is many times larger than the combined net income of all people and businesses. As compared to this immediately preceding example, this new money transfer tax would yield revenue of 5% of total gross receipts of all businesses combined, as opposed to only 1.5% of total gross receipts under the current conventional income tax system. That is 3.3 times (an increase of 233% over the current income tax system) the tax revenue from these businesses as compared to the current income tax collection from the same businesses. In the above example, when the economy deteriorates and total receipts for these businesses drop by 10% and net income drops to 1% of total business receipts, this new money transfer tax revenue will only decrease by 10% instead of decreasing by 89% with the current income tax collection system. The enormous total increase of 233% tax revenue from the single money transfer tax will compensate for the elimination of almost all other forms of taxation.

The money movement tax is applicable to substantially all fund transfer methods. These methods are inclusive of check writing, cash payment, wire transfer, credit card payment, debit card payment, Internet money transactions, international money drafts, money orders, stock and bond transactions, and all account settling methods for stock and commodity transactions.

By applying the tax at the level of fund transfers primarily within banking institutions and the like, this tax system eliminates the need for individual accounting and bookkeeping for tax purposes. Yet there is an accounting at the exit and the entry end of money transfer transactions so that better than 99% of all money transfer transactions have an audit trail. This benefit is directed toward the citizen or small business at the grass roots level. Individuals and some small or simple businesses are freed from tracking finances other than for their own information and purposes. The responsibility for collecting tax and paying it to suitable authorities is removed from these businesses, since they have met their tax obligation simply by paying their bills and by depositing their receipts. As a practical matter for many citizens and small business, bookkeeping can be reduced to a checkbook record and folders of paid and unpaid bills.

The invention can reduce tax-related burdens at the grass roots level. However, larger or more complex businesses and public entities will still need profit and loss accounting procedures. They will continue to need accounting for internal controls and for financial reports to stockholders or partners. The assistance of financial and accounting experts benefits larger business for reasons beyond merely keeping tax records. Therefore, no system of tax reform can promise to entirely eliminate all need for financial records.

A substantial benefit for large and small businesses alike under a tax system of this invention is that business decisions can be made without having to consider tax consequences affecting the bottom line. Capital equipment investments are no longer subject to write-off schemes. Losses made in one year do not enter into tax considerations in following years. Year-end income statements need not be manipulated with large write-offs or write-downs for tax purposes. Long term business planning is no longer in jeopardy for reasons of uncertainty of ever changing tax laws and regulations and audit interpretations of nebulous tax laws.

The individual citizen and small or simple business, which are proportionally most burdened and challenged by the current income tax system, could eliminate much detail and drudgery from their daily routines. The savings to these grass roots taxpayers can be significant. They no longer must track receipts for deductions, seek tax loopholes, purchase tax shelter investments, utilize foreign tax heavens, or track tax write-offs. Inheritance taxes, which are widely acknowledged as detrimental to small sized or family run businesses, could be eliminated, as well.

Financial institutions such as commercial banks and credit card processors are the front line agents for administering this tax system. Their existing accounting and processing systems form a base for administering the method. The services and equipment employed by banks and other money movement agencies constitute the primary infrastructure for collecting tax revenue by this method.

Tax determination, collection and distribution can be localized to preserve governmental accountability to the people. The regional character of a financial institution may serve as a basis for allocating tax shares to the corresponding state and local government. A set of data can be gathered for each transaction to identify the source of taxes and assist in allocating the distribution of the collected tax. This data set includes the recipient's identity and the identity of the recipient's local tax jurisdiction. The local tax district typically is that of the individual or business that received payment. A portion of the tax collected is paid to this same tax district. A similar data set can be gathered about the payor. This information is coded and can be used to distribute a portion of the tax to the payor's local district.

The sets of data identifying payor and recipient can provide accurate economic data about each area of the economy. The sets of data may gather specific alphanumeric codes that identify each category of business on either or both ends of a money transfer transaction. This data can produce an improved quality of localized economic information about each geographic region. For example, car dealers in each geographic region are assigned their own code number, which will enable a daily report of automobile purchasing activity on a local, regional, or national scale.

This data can provide highly accurate economic statistics, which can be utilized for numerous beneficial purposes including economic forecasting, tracking income distribution, adjusting inventory, and recognizing popular trends. The data can be posted on the Internet as public record with almost immediate public access. Businesses can track and respond to developing commercial events and trends. Governments can act upon certain economic trends more immediately by increasing or decreasing their own financial activities to stimulate or temper the economy, as needed.

A localized tax system may establish the tax rate, collect the tax, and distribute it on a diversified, state wide but preferably county wide, city wide, or other local jurisdiction basis. An advantage of a localized system is that it can localize financial decisions and maintain governmental accountability. The local voters will see the impact of the deducted tax in the cost of local business services and goods. The local tax rate will be increased by the tax rate required by all higher taxing authorities that overlap or include the local authority. Thus, a local, city-wide tax jurisdiction might impose a 5% transfer tax in order to collect 2% demanded nationally by the federal government, plus 2% demanded by the state, plus 1% for county and city.

The public perception of a fund transfer tax system should be favorable as compared to the present system of withholding taxes from paychecks. Under an income tax system, employers withhold a portion of every employee's periodic paycheck and submit the withheld tax to government on the employee's behalf. This currently withheld tax is highly visible and appears on every periodic wage statement. Regrettably, the withholding tax does not satisfy the government or release the employee from keeping records, self-reporting, and paying deficiencies, annually. Thus, citizens have frequent and unsatisfactory interaction with the current income tax system even at the level of the individual employee.

In contrast, the fund transfer tax system is less visible. Overall record keeping is substantially less than is required for the income tax system. The individual taxpayer need keep no records and is not subject to enforcement and audit. The transactions from which the tax is deducted can be adjusted to substantially eliminate the perception of taxation. Each seller of goods or services can accommodate the money movement tax system by remaining aware of the rate of taxation and adding the appropriate amount to the billing price of goods and services. An increase in price or service fee equal to the rate of tax effectively compensates for the percentage tax that will be deducted from each deposit to a bank account.

Just as the merchant can calculate the tax into his sales prices, an employer can add the percentage of the tax to wages and salaries paid to employees. Such additions can compensate for the amount to be deducted when funds are deposited to banks or paychecks are cashed. In the case of employee paychecks, the 5% tax can be presented directly on the paycheck as an amount that the employer has added. The paycheck can present the wages as a net amount that will be paid or credited to the employee. The paycheck can carry a separate data entry for the amount of the tax to be collected by the bank when a check is deposited or cashed.

A deposit of a paycheck to a bank account will involve at least two accounts: the employer's account for withdrawal and the employee's account for deposit. When the two accounts are located at separate banks, such a transaction will involve two banks: the employer's bank and the employee's bank. Each of the two banks deducts the money movement tax of, for example, 2.5%. In total, the tax is a combined 5%. The deposit to the employee's account reflects the face amount of the check less the 5% tax, producing a 95% deposit to the employee's account. The employer's bank deducts 100% of the face amount of the check from the employer's account and transfers the face amount less 2.5% tax to the employee's bank, producing a 97.5% transfer to the payee's bank. The payee's bank deducts another 2.5% from the funds arriving from the employer's bank and credits the residual 95% to the employee's account. Each of the banks transfers the 2.5% tax to a separate tax account. The transaction does not require an actual deposit to the employee's account. In addition, the bank cashing a check or depositing a check may charge a service fee.

Variations in how a check is negotiated will produce the same quantitative deductions. If the paycheck is merely to be cashed, it can be cashed either at employee's bank or employer's bank. In either case, the employee will receive 95% of face value. The employer's bank will deduct 2.5% upon moving funds out of the employer's account, and the bank receiving the moved funds will deduct an additional 2.5% tax. If a single bank handles both side of the transaction, such as if the employee cashes the check at the employer's bank, or if the employee and employer use the same bank, then a single bank deducts the entire 5% tax. However, for bookkeeping purposes, 2.5% is deducted upon withdrawing the funds from the employer's account, and 2.5% is deducted upon payment to the recipient employee. While this example focused upon a single common type of check negotiation, it demonstrates a preferred method of collecting tax upon a money movement represented by a check or other negotiable instrument, whether viewed from the perspective of a deposit or a withdrawal.

Each business, by doing business with a bank, indirectly helps to collect the tax. However, the business need not experience the tax as a loss of income if the amount of the tax was anticipated and added by the business to the price of goods sold or services rendered. The buyer of the goods or services does not experience the tax either because it is incorporated in the price of the goods and services.

Wage earners should anticipate that the tax percentage would be deducted from each paycheck when it is negotiated, but the net amount to be paid out by the bank can be written or printed in the usual right hand position on the check, while the tax amount can be shown at another location, such as in the lower left hand of the check. The impact of the deduction is quite small, and generally it is less than rates of withholding tax under the income tax system. Employers can issue payroll checks that clearly state the net amount employees earn in bold and show an additional smaller (about 5.3%) amount paid to the employees in the form of an employer's contribution that compensates exactly for the 5% tax deduction made by the bank from the deposit. The mental impact of tax to the employee will be minimal, knowing the anticipated tax amount already has been included in the paycheck. Thus, income can be maintained at true net wage or salary.

Those who deposit cash into a bank account may see the fund transfer tax most directly, as the bank receiving the deposit deducts the entire tax percentage from the cash deposit. Thus, some cash likely will not be deposited into banks. Large cash recipient businesses will have to make substantial cash deposits to meet payroll and merchandise payments. Such larger businesses like grocery stores, department stores, amusement parks, fast-food establishments etc. may be required by law to deposit all cash received.

A cash economy may be favored among smaller businesses and those who wish to save on taxes. An underground or cash economy is reported to exist with our current income tax system. There would be no reason to expect the cash economy to expand in any substantial way. The incentive to avoid a small tax such as 5% is smaller than incentives to avoid taxation under an income tax system.

Under the current income tax system, cumulative incentives encourage cash transactions. For example, an unreported cash purchase and sale transaction might avoid sales tax, which is often more than 5%. A seller receiving undocumented cash might not report the cash for purposes of income tax, which would reduce the seller's total reported income and result in a lower income tax liability.

However, conducting substantial business for cash is dangerous, difficult, and in some instances, impossible. A large portion of modern commerce operates through transactions by credit card, debit card, and negotiable instruments, all of which enter the banking system at some point. Thus, a money movement tax system will apply to the total value of substantially all banking transactions and reach substantially all money transfer transactions. Cash transactions likely will amount to less than 1% of the total.

Systems of taxation traditionally exclude certain types of activities and offer special treatment to others. The money movement tax system essentially has no tax returns and does not offer an opportunity for the taxpayer, himself, to declare favored tax activities and deduct donations. However, the money transfer taxation system can make provision for special situations. Some of the more common special situations are addressed here and provide concepts that can be applied whenever and wherever needed.

Optionally, the tax treatment of traditionally tax-favored entities is changed in a way consistent with the overall goal of simplifying taxation or to accommodate the needs of such tax favored entities. Traditionally, donations to charitable or non-profit organizations have been tax-deductible. Because this new tax collection system no longer requires the filing of individual tax returns, charitable contributions no longer provide tax-deductible items as a direct financial benefit to the taxpayer. Of course, it would be possible to permit the transfer of money to certain organizations without deducting a tax percentage. However, such special exceptions to the tax collection system would be inconsistent with goals of achieving uniformity and simplicity in the tax system. Donations to support charity would remain possible at the taxpayer's discretion, although without creation of special processing for such donations, a donation would be subject to tax on the money movement transaction.

Optionally, this money movement tax system can provide for a standard share, for example 10%, of the total 5% tax revenue, to be reserved for payments made to causes chosen by the individual taxpayer. Such payments at the direction of the taxpayer can support traditionally deductible contributions to charitable and beneficial organizations such as charities, political parties, election funds, and the like in a method compatible with the desires of the individual citizen or taxpaying entity. The parties to any money transaction can be permitted to take advantage of the computerized aspect of the tax system by identifying a beneficiary charity at the time of making a money movement transaction. According to one method of supporting such organizations, the charity obtains a tax code that is associated with its bank account. An individual wishing to contribute to the charity submits this code as a data tag to a bank together with a transaction for deposit. The code causes the bank's automated data processing equipment to apply special treatment to the transaction. Specifically, the code causes the bank to route an allowed share of the normal or 5% tax payment to the account of the indicated charity. Thus, for example, an employee depositing a paycheck could donate 10% of 5%, which is 0.5% of the check, to a charity.

According to an optional modification, the holder of a bank account is allowed to designate that a specified share of all taxes derived from transactions with the account will be shared with one or more charities designated by the account holder. With the elimination of traditional income tax returns, this method of charitable support is best implemented by allowing each taxpayer to designate his chosen charities and other desired contributions. Enabling legislation can authorize a contribution limit, either in a percentage or an absolute amount. Thus, for example, an employer could mark its payroll account to donate 10% of 2.5%, which is 0.25% of payroll, to charity. If this option is chosen, each side of a transaction may be limited to a percentage of its half of each transaction. Thus, the employee depositing a paycheck may be similarly limited to donating 10% of 2.5% to charity.

The selected contribution may be deducted from the collected tax and subtracted from the share of one or more of the overlying tax jurisdictions. For example, the two highest-level tax jurisdictions will be state and federal government. Following traditional practice, shares intended for these two high level jurisdictions could be slightly reduced to allow for charitable contributions.

As another option, any local tax area or tax jurisdiction can authorize the collection of a supplemental amount or surcharge to benefit charity. This charitable support would be collected along with tax amounts for the tax jurisdictions, treating local charity as another tax jurisdiction. The charitable share can be set according to the reported needs of local charity or at a level corresponding to traditional donations from the tax area. Thus, the local tax rate can be increased to include the expected contribution. With a special fund collected for charity, each tax jurisdiction will receive its full allocation, without deductions; and the parties to a money movement transaction need not or cannot redirect to charity any portion of their transaction taxes.

As an example, if an employed citizen wished to donate the maximum tax-free contribution to a charity XYZ, he could do so by filing a notice of charitable contribution to XYZ at 100% of the permitted amount with his bank. This information would be coded as an attribute of his account, to which he deposits his wages. Correspondingly, as the bank collected the standard percentage of tax from deposits to the account, the bank's processing system would react to the coded charity information to record and reserve 100% of the legislatively permitted charitable percentage from that citizen's bank account deposits. Such a charitable percentage would be a sub-component of the transaction tax, included within the tax percentage taken from each transaction. The bank, or a higher administrative authority, would collect and transfer the reserved funds to the charity on a regular basis. The tax-supported aspect of this contribution would generally be proportional to the citizen's income, while being limited in percentage. Similar results and limitations are found under the present income tax system, and it appears that charities currently are satisfactorily supported.

Another optional method of funding charity is to allow the bank or other tax agency to calculate the donor's intentions from the donor's indicated percentages of 100%. A pre-established entitlement limit such as 10% may cap the total available deduction from any one taxpayer. A cap on donations to any one charity may help to diversity of donations among several causes. For example, the individual charity cap may be 25% of the donor's total available entitlement, which would require that the donor elect at least four charities if he wished to use his entire donation entitlement. Any unused part of the total entitlement could be directed to a legislatively chosen public cause, such as reducing the national debt.

If a donor elects 100% donation to a single chosen charity, the bank's tax software would calculate the allowable donation. This sample instruction would result in application of the individual charity cap, such as 25% of total available entitlement being given to a single chosen charity. The election of additional charities results in all donations being pro rated against the entitlement limit. Thus, four donations of 100% would result in four charities receiving 25% of the entitlement limit. Five donations of 100% would result in five charities receiving 20% of the entitlement limit. Thus, the donor can designate any number of charities to receive his donation on a relative basis between 0-100, while allowing the tax software to calculate the pro ration.

This new system of supporting charity can be expected to raise more charitable contributions than conventional systems. Often citizens have good intentions to contribute to charitable causes but fail to act upon them. This problem is overcome because the tax collection system empowers each citizen to direct a limited personal fund of predetermined size or percentage to charitable causes, without obvious cost to the citizen. In addition, a compilation of the population's choices to receive this discretionary fund would provide an accurate database showing public sympathies and favorite causes. This database would provide an accurate picture of public opinion on many subjects. Funding political campaigns from this source diminishes the influence of special interest groups and gives more political weight to the opinions of the popular majority.

Further, the money movement tax collection system may provide that any part of the charitable share of collected funds is lost by default to the tax jurisdictions if a taxpayer fails to direct the prospective contribution to a charity or cause of his choice. The ready availability of funds for charity would offer a strong incentive for each citizen to select and support charitable causes. The potential loss of otherwise readily available funds can motivate charitable organizations to more strongly promote themselves and their works. The transfer tax demonstrates likelihood that it will improve the welfare of society. It may increase the involvement of the individual citizen in choices to support a wide range of programs to benefit the general welfare, whether in areas of religion, environment, health, education, or the like.

Preserving or creating additional sources of tax revenue can benefit governments and society for a variety of reasons. Supplemental tax systems can co-exist with the fund transfer tax system and may serve additional purposes. For example, it may be desirable for real estate property taxes to remain as a separate source of governmental revenue. The power to tax real estate permits legislators to limit or oppose monopolies in real estate property. Other indirect consumption taxes such as gasoline and utility consumption taxes are useful for applying an economic incentive to preserve the taxed resource. In addition, because these taxes are automated and included in regular billing statements or other payments, they do not add to the record-keeping burden of the average citizen.

Such additional sources of government revenue may be desirable in certain tax jurisdictions. For example, a supplemental source of tax revenue would aid a tax jurisdiction that does not have sufficient nexus to money transfers to meet its special budget needs.

In order to encourage or at least to not unduly inhibit certain sizes and types of transactions, a special rate of the tax can be established to apply in appropriate circumstances. The tax applied against a money transfer transaction can be keyed to transaction size or to the type of financial transaction. For example, stock, bond, and commodity transactions may be taxed at an extremely low rate. Wire transfers may be taxed on an inverse sliding scale, such that the larger the transaction, the smaller the percentage deduction. A similar inverse sliding scale may apply to checks drawn in large amounts. The money transfer tax on cash deposits may be small or zero, to provide an outlet from the cash economy into the banking system. On the other hand, cash withdrawals may be taxed higher, as a disincentive.

Thus, by allowing special tax percentages, this tax system still can address special needs, preferences and policies. Significantly, the average citizen is not burdened by these special situations unless he chooses to become involved with them. Unlike the citizen's treatment under current tax laws, his ignorance does not lead to civil or criminal penalties. A citizen having dealings with a charity, stockbroker, or other favored entity receiving special tax rates can receive timely guidance from the favored entity, itself. In substantially all cases, the only action required of the citizen is to add a code to his check, if paying by check, or otherwise ensure that the transaction is tagged with the appropriate code for special treatment.

A software system or Internet based accounting system for the banks receiving or paying the transaction amount performs the appropriate calculations and fund routing. Thus, a charity, stockbroker, or favored entity bears the burden of gaining approval for special handling of its accounts with the government or taxing authority. A bank must obtain a suitable identification code that it can supply to those who transfer funds to it. Finally, banks must ensure that the software routines in the tax processing computer systems are functioning properly to apply the special tax rate and route funds to the favored account. As consistent with this tax system, the larger and well-funded entity bears substantially the entire burden of administering the system. Banks and similar financial institutions are audited regularly even without serving as tax collectors. Similar close scrutiny by tax authorities under the money movement tax system would be fully appropriate and properly applied to suitably prepared and capable entities. The average citizen is freed from substantially all burdens, although by simple steps he can express optional financial choices.

Once implemented, the money movement tax system should relieve citizens and many businesses of tax related record keeping requirements and reporting requirements. Numerous individuals and small enterprises in the country would gain privacy and a sense of integrity because they are neither called upon to self-report nor subjected to the burden of audits. In addition, many entities will see an immediate reduction in overhead costs and/or increase in useful productivity by being relieved of the tax accounting burden and expense.

In operation, the tax system may be structured as described in the following advisory examples:

The tax rate for all transactions below $100,000 could be a total of 5%, which is partially deducted at both ends of the transfer at 2.5% each. Above $100,000 the tax rate can be established on a sliding scale that decreases to 2.5% for a $2,000,000 single check or wire transaction and further decreases on a sliding scale to 2% for a single $5,000,000 transaction. The dollar values on the sliding scale can be established as of a base date, such as Jan. 1, 2003. Thereafter, the dollar values can be adjusted to accommodate changes in cost of living and inflation in general.

The money movement tax can be applied to selected types of activities, which may be deemed special activities, in ways that accomplish social, economic, legal, or political objectives. As one example, the tax on stock and commodity trade settlements may be set at a rate that will temper manipulative, short-term trading but will maintain a healthy flow of transactions to maintain good market liquidity. This type of market management seems desirable, based upon the opinions of financial experts who suggest that free enterprise will benefit if manipulation of financial markets is tempered. The lower rate is implemented by use of a code submitted to a bank with each transaction or arranged as a property of the related accounts. The code causes the transaction to be given automated special handling, which is dictated by software associated with the code. The software may cause a special tax rate to be applied to the transaction. The stockbroker or commodity broker must obtain the code and ensure that the associated software routine performs in the desired fashion.

Other types of money transfer transactions, i.e., transfers of stocks, bonds, mortgages etc., can be taxed as deemed appropriate. Each transfer of a stock, bond, mortgage and other type of security and commercial paper is subject to a suitable tax at a low percentage rate. These extremely low levels of taxation on large financial transactions should be maintained at levels that temper financial manipulation, yet allow for an adequate number of transactions to take place in order to keep the financial markets fluid.

A business that is planning a price structure for its goods or services knows what margin is required for the business to succeed. With the further knowledge that a tax of 5% will be deducted automatically from the amount received, the business can increase gross sales price by, for example, 5.3%, to compensate for payment of the 5% tax. This added cost to the price of a product or service is similar in financial impact to the cost of the 1% to 3% of each credit card sale as is commonly charged to merchants by a credit card processing company. Presently the majority of businesses do not impose a retail price difference upon transactions by credit card versus those by cash or check. This evidence suggests that the price burden of a gross receipts transfer tax sized on the order of 5% is minor and of little impact on the overall business economy.

This similarity in percentage of cost suggests that businesses have found a corresponding benefit that offsets the credit card percentage burden. The processing fee a business pays to a credit card company may be offset by the benefit of fewer unpaid accounts, elimination of losses by bad checks, and a possible increase in customer purchases due to the ready credit available on a credit card. Similarly, a business may find the transaction tax profitable in other ways, such as in reduced time and costs of tax accounting, and in reduced record keeping and reporting related to withholding payroll taxes.

With the elimination of payroll withholding taxes as unnecessary, employees may find a net increase in take-home pay corresponding to part of the savings in cost of administration to the employer. The software operating the tax system can be modified to assist administration of employment benefits. Employers may be required by law to pay wages and salaries on specially marked checks, such as with bar codes or other electronically readable markings. These codes can indicate the amount of extra benefit payments that have been included within the check. When the check is deposited, the codes cause special handling. The benefit payments can be deducted by the banking institution and paid to the appropriate benefit providers, as implemented by the software routines activated by the codes.

Under the new taxation system of this invention government revenues can be in excess of what is raised by the income tax system as it is operated today. The implementation of a money movement tax holds the potential to increase the quality of life in the tax jurisdiction. Increased revenues might be used for increased public expenditures to enable improved quality of life and improved public services. Thus, it would be possible to improve parks, public swimming pools, beach facilities, public schools, libraries, city halls, performing arts centers, universities, basic research centers, airports, harbors, roads, and public transport. The jobs eliminated from the 30,000 taxing agencies can be recreated in these areas of increased public improvements, bringing about better quality of life.

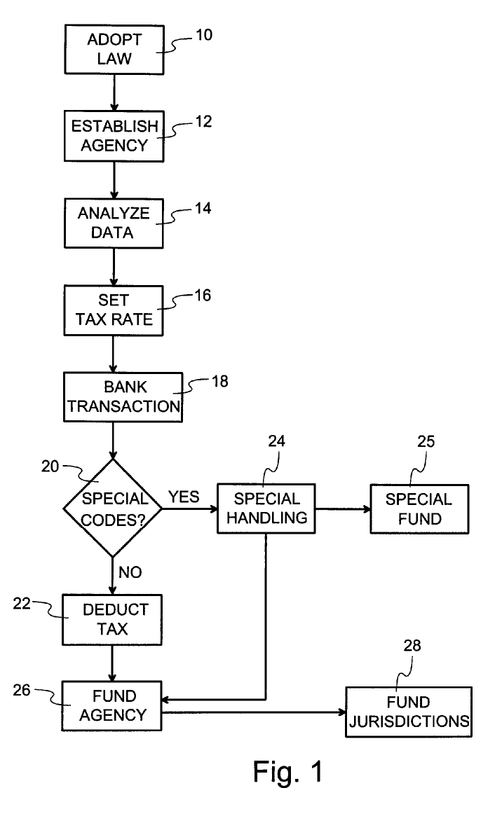

With reference to the drawings, FIG. 1 shows an implementation of the transfer tax system. The steps can be conducted in an incremental manner so that the system's operation and revenue producing capability are reliably established before traditional income tax is terminated. The first step is a legislative adoption at block 10 of a money movement or gross receipts tax system. Adoption at the federal level is most desirable, since the federal income tax system comprises the heart of the problem for the citizen taxpayer. The cooperative adoption by one or more states is equally desirable and perhaps essential, since states tend to follow the federal income tax scheme. Various city or local tax systems could follow the federal and state schemes in due course. These local jurisdictions would be encouraged to follow the same system, since the local citizen or business would object to maintain records purely to satisfy a local taxation scheme.

An ideal implementation of the new tax system would establish an identical tax percentage in all locations of the country, replacing other forms of taxation and licensing fees, with possible exceptions for separately collected property tax, energy tax, and fuel tax. In order to adopt an operable system, suitable tax collecting authorities or agencies may be established or authorized at block 12 and equipped to administer the system. In a network of tax jurisdictions collecting their revenues according to a budget, it would be desirable for a central tax collecting authority, such as a local or state authority, to accumulate the budget needs of participating tax jurisdictions within the state, including the federal government's partial jurisdiction over the state. Thus, one or more central tax collecting authorities, such as state level authorities, are established to monitor tax revenue needs within one or more centralized areas such as states.

On a periodic basis such as the budget year, each jurisdiction must determine a budget, considering its needs for the period. It is desirable to predict or estimate a gross value of monitorable money movement transactions having a nexus to the jurisdiction. The central tax collecting authorities might provide estimates to the jurisdictions within its area. Those transactions provide the base that will be taxed over the year. One approach to obtaining this economic data is to poll banks and banking entitles serving the tax jurisdiction for their expected volume of transactions having a nexus to the jurisdiction. Other helpful economic data may include local rates of growth, consumer spending, factory productivity, and inflation rate data.

After analyzing relevant budget and economic data at block 1 4, each tax jurisdiction can set its own applicable tax rate or rates at block 1 6. This rate is expected to be at least the percentage that the budget constitutes of the applicable projected gross money movements having nexus to the jurisdiction. As a matter of efficiency and economy, a state level office can gather budget reports, perform the economic study, and set the local tax rate for each of the included local jurisdictions. The tax rate set for each local area will cumulate the necessary rates to satisfy the local budget and all higher-level budgets. Thus, each local area collects the cumulative tax required for itself and for every higher tax jurisdiction that has nexus to the local area. In addition, a tax authority at any level should be able to review and audit the operations of any other agency to determine compliance with the tax laws.

It may be desirable for a single tax rate to be set over a statewide area or other high-level region. A state level office can determine the necessary tax rate by cumulating the budgets of all included tax jurisdictions and comparing the total to the expected total of money transactions in the same regions. A single high-level tax rate is likely to be based upon more accurate and reliable economic data due to the larger size of the database and, perhaps, the availability of more economic expertise.

The tax authorities also receive the deducted tax funds from the various banking or financial institutions and distribute the funds to the participating tax jurisdictions in proper amounts. Alternatively, the tax authorities oversee that the banks, themselves, properly distribute the collected tax. Banks can perform the distribution function through electronic transfers to the tax jurisdictions on a frequent basis, creating a regular or continuous flow of funds.

The federal Internal Revenue Service presently performs certain of these functions. That agency is suited to serve the federal government in the same capacity under the new taxation system, although likely needing far fewer employees. Noting that the preferred operation of the tax system is centered at the state or local level, it would be appropriate for state or local agencies to be active participants in the administrative process. For purposes of example, the system will be described with respect to a statewide central revenue disbursement authority (SRDA). The functions of SRDA can be carried out either at a lower or higher level.

The system must be made operational. Banks and other selected financial processing institutions will be informed of the tax to be collected and will administer collection of the tax against applicable money movements at block 18. Terms such as “bank” or “banking entity” will refer broadly to any entity that processes money transactions and is charged by law to collect the tax. A narrow and specific definition of a bank is a business establishment in which money is kept for savings or commercial purposes or is invested, supplied for loans, or exchanged. Banks falling within this definition constitute important parts of the tax collecting system. However, still other types of businesses may become parts of the tax collecting system. Businesses that cash checks for the public may be regarded as banks, because the processing of checks is a major form of money movement. Similarly, credit card processing companies oversee large money movements. Any of these may be authorized and required to participate in the tax collecting system. Generally, banks may include commercial banks, merchant banks, savings and loan associations, credit unions, financial processors such as credit card service companies, savings banks, Federal Reserve banks, check cashing businesses, stock brokerages, and securities clearing houses.

These financial institutions are of differing size and ability. A major bank may include clearing functions or tax submission functions within its structure. Smaller banks may perform only limited internal processing and may send out much of the remaining processing to clearinghouses or larger banks. The description of steps performed by a bank may refer to multiple steps performed by a single banking entity or by sub-units within a single institution, or by an association or series of separate institutions operating in cooperation. It would be preferred that all banks be associated with a computerized network for processing financial transactions, such as, for example, the Federal Reserve System.

Suitable software is a key element to the success of the system in taking over the burden from the small taxpayer. Account management programs must accurately and uniformly collect and submit the tax. The software must respond to any codes indicating special handling of any transaction. If desired, the processing software may detect and correct double taxation for certain transactions such as credit card payments. Banks should be entitled to fair compensation for their services in the collection system.

Each bank processes money transfer transactions, deducts tax, and transfers the tax to an agency in the tax distribution system, such as SRDA. Automated check reading equipment and similar processing equipment can review each incoming transaction and all accompanying data, such as indications of applicable tax jurisdictions in order to apply the correct tax rate, if various tax rates are employed. Transactions also are automatically reviewed to discover special codes or other indications that special handling is required, at block 20. In the absence of required special handling, the transaction is processed for the normal deduction of tax at block 22, as required by the applicable jurisdiction.

Where appropriate due to special codes or account attributes, transactions are given special handling at block 24. This arises, for example, when a transaction carries a code calling for a low tax rate, donation to a charity or special fund, or sending payment to an employment benefit provider. Special handling may include substantially any sort of processing outside normal processing. The party benefiting from the code is responsible for arranging the special handling, such as to ensure that a special fund 25 has been established to receive the suitable contributions. If any amount of tax is collected by special handling, the tax is submitted to SRDA at block 26.

The tax agencies or SRDA receive the taxes from banks at block 26. Their function includes distributing the tax to each included jurisdiction at block 28. Distributing may take place by forwarding proper shares of tax to the various included tax jurisdictions.

In a typical tax collection process, the initial tax-collecting agency, such as a bank, receives a transaction, identifies and processes codes for special handling, deducts the appropriate tax and performs any special requirements. The bank then transfers the deducted tax to the appropriate tax authorities and distributes special items to other appropriate recipient accounts. Accordingly, the collected taxes are directed at block 28 to the tax jurisdictions, and any other special collected funds are distributed to the suitable recipients at block 25.

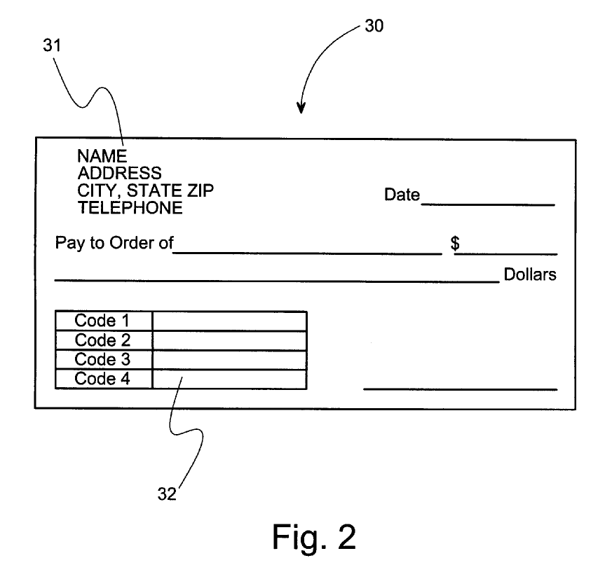

Almost any citizen easily can interact with the tax system in order to take advantage of special tax rates and provisions. This interaction can be initiated by use of a bank check or draft 30, shown in FIG. 2 to include conventional data area 31 including drawer's nexus information such as name, address, and telephone. The design of the check includes the addition of a special entry field 32 positioned for automatic reading by check processing equipment. The specially configured checks 30 are used in the tax system to carry an optional code field 32 for indicating special handling. The maker of the check can enter one or more codes to identify a charitable payment, stock transaction, or other type of payment deserving a lower rate of tax or other special handling. The code entry may have multiple fields to convey a preselected variety of information, such as both a code and an amount of money. One code field on paychecks can list the amount of the proper tax deduction so that the employee can be assured he is receiving the proper net pay.

The exact content of the code fields and the scope of information are variable according to the prearranged needs of particular situation. Ultimately, a code may call a particular software routine to process the check in a prearranged way. A code may refer to a bank account of a special recipient of funds, who is entitled to receive funds with special tax handling. A code may indicate a size of deduction from the transaction for such a special account. Placing a code on a check is merely one convenient way of obtaining special handling of a transaction. Any transaction can be coded, such as by entering a code electronically when depositing to an automatic teller machine, informing a live teller to enter a particular code, entering a code with a credit card transaction, or entering a code on an informational report such as a deposit slip when performing a transaction. Internet banking may provide additional possibilities for on-line money transactions and associated coding.

In minimizing burdens on the ordinary citizen, a check or other payment should require no more than a code entry to remove the check from the normal tax collection process and initiate special handling. For example, a coded entry to designate a charitable contribution or any other special factor should trigger a software handling routine that performs all other necessary processing. The burden of ensuring that the processing is correct falls upon the entity holding the code. Business checks such as paychecks may carry plural code areas 32 in order to enable complex coding and handling, such as processing benefit payments as previously described. The code area 32 permits an alphanumeric entry, a bar code, or other machine-readable entry.

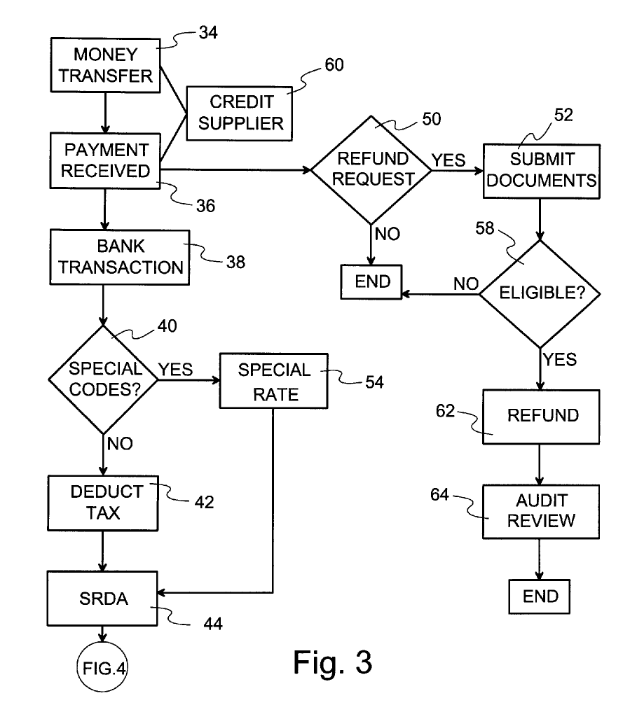

FIG. 3 shows the general operation of the money transfer tax system. One type of transaction is a one-party transaction, such as a report of cash on hand. A true one-party transaction, in which no transactional source of the funds is involved, may be rare, but the tax system will accommodate it.

Most transactions can be analyzed as two-party transactions, where money is transferred from a first party to a second party. The first party typically will be a transferor of funds consisting of cash, credit from a credit account, or value from a stored account, i.e., savings or checking. The second party receives the funds and deposits the funds to an account in a bank. Depending upon the structure of the tax system, the two-party transaction may focus upon the receipt of funds, the payment of funds, or both. A two-party transaction may resemble a one-party transaction at the point the second party deposits a check into a bank. However, the two-party transaction offers at least two extra features: the tax nexus of the first party may be included in the data associated with the deposit, to influence the eventual distribution of taxes; and a check may carry a code for special handling of some aspect of the transaction at the first party's election.

Another type of transaction is a three-party transaction. The first and second parties may be purchaser and seller, respectively. The third party likely is a credit supplier, who aids the transaction by paying the second party for the purchase made by the first party. In due course, the first party repays the third party, often with interest. This situation adds new complexity to the operation of the tax system. A variety of specific one-, two-, and three-party transactions will be applied to the scheme of FIG. 3 to show available tools for fairly operating the tax system.

A cash transaction provides a simple example of the system's operation. Because the tax can be universally applied, the purpose or origin of the cash is not necessary information, although a code may be applied to a cash transaction as readily as to other types of transactions. In one form, the transaction starts with a party who receives cash in a money transfer at block 34 or otherwise is in possession of money. Because no first party payor will be identified for purposes of a one-party transaction, the single party can be referred to as the second party payee who is in possession of a payment or quantity of money from any source at block 36. The second party is a financial customer who will use the service of a financial institution. The cash can be accounted for and taxed with or without an associated deposit transaction of the cash into a bank.

A first type of one-party transaction is the voluntary report of cash received, such as by a business holding cash-on-hand at block 36. The holder of the cash prepares a report and files the report with a bank at block 38, without a deposit of the cash. Such a report may be similar to a deposit slip with added data fields for tax nexus information. If the holder wishes to keep the cash instead of depositing it, the holder submits the report together with a payment for the tax due on the cash, if any. The preferred method of operating the tax system imposes no tax on a pure cash report to a bank. In this mode of operation, the bank records the reported data without deducting any tax. The transaction complies with the processing scheme of FIGS. 3, wherein the bank reviews the deposit slip for applicable special coding at block 40 and notes coding showing a cash report. At block 54 the bank applies a special tax rate such as zero for a cash report and forwards the zero collected tax to a tax collection authority at block 44.

If it is optionally decided to tax a cash report, the bank may find that no special code appears at block 40 and will process the receipt of the accompanying suitable tax amount at block 42. The bank then directs the tax payment to a fund of collected taxes at block 44 and records any related data from the cash report form. If a cash report is to be taxed, the proper rate is one- half the full tax rate, such as 2.5%, because the one-party transaction resembles only one-half of a full, two-party transaction.

As another alternative, the cash report is submitted at block 38 without any accompanying tax payment, but the reporting party holds an account at the bank. The bank can deduct the tax at block 42 from the reporting party's existing account balance with the bank. Because cash is spendable without the intermediate services of a bank, the loss of the tax amount on each cash deposit may discourage any sort of cash deposit. Thus, a wise provision would allow the deposit of cash with little or no tax on the transaction.

After the bank has obtained the appropriate tax, if any, on the report, the bank electronically transfers the tax funds and the data from the cash report to a tax agency such as the State Revenue Disbursement Authority (SRDA) at block 44. As an alternative, the banks in a geographic area may submit their taxes and reports to a local tax agency serving the area. Using electronic transfers and a computer network, the tax agencies can route and reroute tax submissions however desired or required.

In a second type of one-party cash transaction, the cash held at block 36 is deposited to a bank account, accompanied by a cash report, at block 38. The bank receives the deposit and cash report, considers special coding at block 40, deducts the appropriate tax for one-half of a full transaction on the full reported sum at block 42, and credits the remainder to the taxpayer's account. The bank completes the transaction by transferring the tax and the data from the cash report to SRDA at block 44.

Another half of the full transaction takes place in a one-party cash withdrawal from a bank account, where the withdrawal request is processed at block 38. Once again, the withdrawal is reviewed for special processing at block 40, where either a special rate is applied at block 54 or a standard rate of one-half of a full transaction is applied at block 42. Any tax collected, such as 2.5%, is send to the central tax authority at block 44. Any entity providing a withdrawal or cash advance must act with knowledge that the check or credit charge enabling the cash advance faces possible taxation and adjust its service charges accordingly.

In a third type of cash transaction, a first party at block 34 creates a money transfer by electing to obtain cash by cashing a check. The first party buys the services of a second party check cashing entity that accepts a check in payment for returning a certain amount of cash at block 36. The second party cashes a check for the customer at block 36, either as a free service or as a business transaction in which the second party retains a service fee. The check cashing entity receives the check and, if such entity is not itself a bank or official tax-collecting agent, eventually it will deposit the check with a bank. Because the check cashing entity is dealing in money and direct money values, it must adjust the transaction to account for any tax burden that later will be deducted from its own bank deposit. In one form of adjustment, the check cashing entity must charge the customer for this eventual tax by a compensatory deduction of the expected amount of the tax from the amount of cash paid to the customer in return for the check. Thus, the face amount of the check is paid in cash to the customer at block 36, with compensatory reductions for the amount of the tax plus a check cashing service fee, if any.

Having engaged in the money transfer transaction at block 34 and received a check in payment at block 36, the check cashing entity will deposit the check to its own bank account at block 38. The bank processes the check at blocks 40 and 42, deducting the tax amount and forwarding it to SRDA at block 44. Because the check cashing entity already deducted a compensatory amount equal to the tax from the customer's payment, the check cashing entity has performed an acceptable business transaction in which it has realized the expected net gain of a service fee.

Any of these cash events may arise from a purchase and sale transaction as suggested by blocks 34 and 36. A customer pays cash to a business at these blocks, and the business sends its receipts to its local bank at block 38, generating a transaction record in the local bank. The processing system used by the bank may take into account the merchant's location, which would be a coded attribute of the merchant's account, to link the cash transaction to the merchant's local tax jurisdictions.

Check transactions are handled within the scheme of FIG. 3. A check from the first party at block 34 is transacted to a second party at block 36. The second party deposits the check at block 38 to its customer account at a bank. At block 42 the bank deducts the tax amount from the face value of the check. As mentioned previously, checks cashed at any business other than a bank or tax agency should be reduced by a compensatory amount equal to the anticipated tax when first cashed, and the bank officially collects the tax by final deduction when the check is presented for deposit or payment at the bank.

The tax system should accommodate mesne negotiation of a check or other taxable instrument. One method of accommodation is by publishing the tax rate for such instruments so that the mesne recipient can know what compensatory deduction is necessary. Another method, perhaps of greater practical importance, is to maintain the tax rate at a readily manageable number. For example, a tax rate rounded to a single digit such as 5% is readily manageable. The tax rate becomes less manageable as the number of significant digits increases, eventually resulting in the mesne recipient performing a rounding off, likely to his own benefit. Therefore, the better practice is to establish the official tax rate at a rounded-up figure that is easy to use in calculations, and which has the further result that it slightly over funds the tax jurisdictions.

A preferred tax rate might be a single significant digit or at least a whole number. Better yet, the total tax rate should be an even whole number so that the rate remains a whole number when halved for allocation between two sides of a money movement transaction. Accordingly, an even whole number rate such as 6% may be ideal, as it allows a halved tax deduction of 3% to each side of a transaction. If it is deemed that one decimal is acceptable, then odd whole numbers are suitable for the total tax rate, and the halved rate will include no more than one decimal. The inclusion of more significant digits in the tax rate could cause a loss of confidence in the fairness of the tax system due to a tendency of mesne holders to round up the compensatory deduction to an unofficial higher rate.

When a payee deposits a check into his bank, the bank creates a record by crediting the amount of the deposit to the payee's account. According to the tax system at block 42, a data processing system at the bank will record the deduction of the tax from the amount of the deposit and credit the remainder to the payee's account. Typically, a payee's bank sends deposited checks through a check clearinghouse, which routes or delivers the cashed check to the payor bank. At the payor bank, another record is created, showing a debit of the face amount of the check from the drawer's checking account. The clearinghouse will provide a dual calculation: the payee's bank is credited with only the post-tax amount to its accounts; and the payor bank is debited with the face value of the check. The difference between the two calculations is the value of the total tax. The payee's bank is responsible to submit one-half of the tax to a relevant tax jurisdiction or collecting authority; and the payor bank is responsible to submit the other one-half of the tax to a relevant tax jurisdiction or collecting authority. The tax submissions can be by transmitting the tax to the authorities or to a clearinghouse for subsequent transmission to the authorities. In either event, the clearinghouse provides a substantiating audit trail.

A bank may serve as the second party, which receives a taxable payment at block 36 in the sale of certain products. Some of these products are money orders, cashier's checks, traveler's checks, certificates of deposit, stocks, or bonds. Any check paid to a bank in purchase of a bank product can be viewed as an ordinary payment to a second party merchant at block 36. When the bank processes the check for payment, the check is viewed as being deposited to the bank's own account at block 38 and taxed as an ordinary money movement at block 42.

Bank products can be viewed as being money or money equivalent products. When a first party customer makes the purchase of a money product, the resulting transaction is similar to the previously described transaction with a check cashing entity. A bank must compensate for the expected tax to be deducted at block 42. One solution is for the bank to provide a money product of value reduced by the compensatory amount. Another solution is for the bank to surcharge the customer by a compensatory amount and provide the money product at the originally requested face value. Like the check cashing entity, the bank later can have the tax deducted from the customer's payment while still realizing at least the money value of the money product sold.

An alternative solution is for the tax system to provide relief by applying a special rate to such transactions. At block 54, the tax system can apply a special tax rate of zero to a transaction involving only the negotiation or exchange of money, negotiable instruments, or other money equivalents.

Another form of relief is to allow a refund or recovery of tax paid on such money exchange transactions. These solutions can be applied not only to transactions within the banking business, but also to any other transaction in which a similar problem arises. Thus, these solutions can be used by check cashing organizations, credit card companies, and securities brokers who receive a payment at block 36. This preferred solution permits the party making certain payments or deposits to a bank to apply for a tax refund at block 50. A taxpayer who elects to apply for a refund at block 50 can do so by submitting supporting documents at block 52 to a tax refund authority. Refunds are discussed in further detail, below.

After the bank has deducted tax from its own transaction at block 42, the bank completes the tax collection process by transferring all tax amounts collected to SRDA at block 44. Tax transfers are accompanied by a report showing the accounts that have made the payments. SRDA can audit the bank to ensure the full amount of tax has been remitted. Tax transfers and tax reports may operate on a bulk basis of total deposits made to accounts within a bank on a daily, weekly or monthly basis.

A transaction in which a third party extends credit on behalf of a purchaser to a merchant seller presents a policy problem of whether the transaction should be taxed as one money movement or two money movements. The complete transaction requires a third party to extend credit to a purchaser, correspondingly to pay the merchant for the purchaser's transaction, bill the purchaser for the credit extended, and collect the account from the purchaser. This cycle produces two separate but related transactions. From the viewpoint of a bank, each of these transactions will be taxed, although this results in an apparent double taxation if the transaction is viewed as a single three-party transaction.

According to FIG. 3, a typical three-party transaction involves a third party credit supplier who provides credit at block 60. For example, a credit card company accommodates a purchase and sale transaction between a purchaser at block 34 and a merchant seller at block 36. Initially the third party credit supplier extends credit to a first party purchaser at block 34 and pays the second party merchant at block 36. The payment to the merchant passes through banking channels and is taxed at block 42. This tax payment is the proper one at which the tax system obtains its share of the overall transaction. Half of the tax is deducted from the credit supplier's account when the payment is withdrawn, and a second half of the tax is deducted at the merchant's account when the payment is deposited.

An apparent second taxable event occurs when the credit supplier subsequently recovers payment for the credit advanced. Then, the credit supplier can be viewed as being the payment receiver at block 36 when the purchaser at block 34 repays the credit advanced in the price of the initial transaction. If this second transaction is taxed, the credit card company may fail to recover as much money as it paid out in the initial transaction. The credit card company would lose money on the overall transaction unless (1) at block 36 it collects a surcharge from the purchaser equal to the tax on the payment made to the merchant; (2) at block 40 it receives special handling leading to a zero tax at block 54 on the amount paid to the merchant; or (3) it requests a refund at block 50 and receives a refund at block 62 of the tax on the amount paid to the merchant.

Another solution is for the credit card company to reduce its payment to the merchant by the amount of the tax on the payment to the merchant. However, the merchant effectively would be double taxed when the bank deducts the actual tax at block 42. Likely the merchant would find this solution unacceptable. Surcharging the credit card customer likely would discourage the use of credit cards and be detrimental to the credit card industry. Therefore, the preferred solution is for the tax system to allow the third party credit supplier to receive special handling or a refund on the amount paid to the merchant. Special handling is not entirely suitable because the purchaser's account payment to the credit card company is not an accurate measurement of the double taxation, as will be next explained. Therefore, a refund system is the best way to correct double taxation in a three-party transaction.

The amount of necessary tax relief is merely quantitatively measured by the amount of the payment made to the merchant. The tax system is applied to receipts and, therefore, the actual payment to the merchant is not taxed from the credit card company's funds. However, one way in which a credit card company makes money is to charge the merchant a small percentage of the initial transaction and deduct this amount from what is paid to the merchant. Consequently, the credit card company receives an extra sum of money when the purchaser pays his credit card bill, and this extra sum should be taxed in the normal way.

In order to accurately measure and prove the amount of money upon which a refund or special handling should be granted, the credit card company might adopt the use of a special merchant payment account. All payments to the merchant customers are made through such an account, establishing the exact total that will be submitted for a tax refund. At refund request block 50, the credit card company can review its transactions and identify those that should be considered for refund. The identified transactions are documented, such as by proofs of the total paid from the merchant account, and submitted to a refund authority with a refund request at block 52.

The refund authority may be an office of the SRDA. The refund authority reviews the documentation at block 58 and determines whether a refund is appropriate. Refunds are made at block 62 by electronic transfer to the credit card company's account. A refund may be issued at a suitably increased amount to allow recipient to receive full value after the refund is taxed. Alternatively, the refund authority may issue the refund with a code calling for special handling of the refund at a zero tax rate.

The refund authority maintains a right of audit review at block 64 to prevent abuse of the refund system. Allowing the credit card company to seek a refund solves the financial imbalance and provides a paperwork trail for monitoring the uses of this exception to the tax system. The burden of record keeping and reporting for the credit card company to gain this refund falls on the credit card company and not on the purchaser. The result is that the government obtains only one tax collection on the price of the initial purchase.

The tax system can use tools such as special handling, zero or low tax rates, and refunds to accommodate problems in processing any type of transaction leading to double taxation or an economically unworkable result. The refund authority can approve any request for a refund that meets established standards. For example, the requestor may be required to show that the government has received its proper tax payment and that the tax system has duplicated the collection within a single overall transaction. The applicant must bear the burden to establish any exception.

Stockbrokers and security clearinghouses may use accounts with a reduced tax rate in securities transactions. An especially low rate or a zero tax rate for these accounts aids in maintaining market fluidity. By establishing a suitable system of coding, the financial institutions can accommodate special situations in the tax system and maintain clear records of taxes collected at any set of tax rates. An alternative method for reducing the tax burden permits each deposit to be normally taxed but allows the broker or clearinghouse to obtain a refund of the tax, as previously described.

A securities transaction is initiated when a first party investor at block 34 opens a trading account by transferring funds to a stockbroker at block 36, where the investor's payment is accepted. The broker deposits the payment into a bank account at block 38, and the bank deducts the tax at block 42. Securities firms may be treated as banks if they maintain the investor's money within their own structure.

The brokerage firm buys and sells securities for the investor's trading account. In each transaction, the brokerage functions as the first party at block 34 and deals with a securities exchange in the position of the second party at block 36. The exchange records each transaction and electronically reports it to SRDA to provide a data trail. The proceeds of each transaction are deposited into the trading account at block 38 and taxed at block 42. The brokerage also settles its own accounts with securities clearing houses. A clearinghouse may perform as a bank at block 38, deduct the tax from each receipt at block 42, and forward the tax to SRDA at block 44.

Securities transactions involve exchanges of money for instruments of equivalent monetary value. Any substantial tax on this type of exchange transaction is likely to inhibit the industry. Consequently, a transaction between a trading account and an exchange or clearinghouse is given a code for special handling at a nominal tax rate. Alternatively, a partial tax refund must be available.

Both purchases and sales of securities are treated as normal two-party transactions. Each is separately taxed, although given special handling at block 54 where a low tax rate is applied. Payments from trading accounts to the investor are not given a special handling code. The normal, full tax is deducted from a payment between the investor and the trading account.

Under traditional tax systems, investment in securities was given favored tax treatment, such as by provisions for long-term capital gain. An optional tax provision in the money transfer tax system can similarly encourage investment. An investor can be permitted to obtain a tax refund on money received back from an investment account. This refund may be limited, such as to twice the tax paid on deposits into the trading account. The standard refund process is used, through blocks 50, 52, 58 and 62. The documentation required in a securities account withdrawal is proof of the amount of prior tax paid for deposits into the trading account.

International transactions involve the transfer of money into or out of the country employing the money transfer tax system. A customer at block 36 may request a bank or electronic funds clearinghouse at block 38 transfer funds to a foreign account. This request is processed through banking channels to block 42, where the bank deducts a normal tax, such as 5%, before sending the balance to the foreign account. Thus, the transfer is handled like a domestic transfer, with the exception that the full 5% tax is applied to outgoing funds. This difference in treatment is justified because the foreign bank receiving the funds transfer is unlikely to submit the tax to the U.S. tax system.

A money transfer from a foreign bank at block 36 into a payee's domestic bank at block 38 also is taxed 5% at block 42. The balance of the received funds is available to the payee, whether deposited to a bank account or disbursed to payee as cash, traveler's check, or other negotiable instrument.

Optionally, an international transaction may be eligible for a tax refund at blocks 50, 52, 58, and 62. A basis for refund may be to offset a tax paid in the foreign country or to prevent undue burden on international commerce. Alternatively, the international transaction may deserve special handling at block 54 to benefit from a reduced tax rate. Instead of a party to the transaction arranging for special handling, the federal government will establish how to tax international transactions as a part of the commerce power delegated to Congress.

A variety of other modes of transferring money are treated according to the general scheme of FIG. 3. A receiving bank will deduct tax from the proceeds of wire transfers and electronic funds transfers before crediting a recipient's account or releasing the funds in any other way. Internet transactions also are taxed at both the paying and the receiving end at 2.5% each end. In Internet transactions across international borders, the transactions are taxed at 5% for the paying or receiving end of each transaction that has nexus to the U.S. taxing scheme. Tax nexus data is reported with each transaction. The various payment schemes employed by Internet traders can establish a tax collection point with either the payee or the payor, depending upon which has nexus to the U.S. taxation scheme of this invention. In this way all Internet purchases or service transactions that have either payor or payee nexus to the U.S. will contribute to the total tax revenue stream.

Money orders, cashier's checks, traveler's checks, and similar money instruments can be purchased as bank products. As noted above, the bank acts as the second party receiving payment at block 36 in such transactions. The payment is processed into the bank at block 38 and treated as a normal taxable receipt at block 42. The first party buyer may be required to pay the anticipated tax as a purchase surcharge, or the bank may seek a tax refund. Independent resellers also handle certain of these instruments, such as money orders. The reseller performs in the same way as a bank, charging the purchaser a tax surcharge. The reseller deposits the purchase money into a bank at block 38, and the bank deducts tax at block 42. Requests for refund or special handling at a zero tax rate offer other options in establishing a monetary balance in the exchange of funds.

As noted throughout, all collected taxes eventually are transmitted to appropriate revenue disbursement agencies such as SRDA. These agencies are charged with the task of paying the collected tax revenues to all of the other tax jurisdictions, from the highest level to the lowest level. For this task, SRDA must have available data allowing a determination of each included jurisdiction's entitlement. For this responsibility, the central revenue disbursement agency is best located at state level. Tax jurisdictions crossing state lines are almost unknown, other than the federal system. A statewide disbursement agency has easy access to records, election results, political boundaries, and legislative records within the state. Perhaps more important, a state agency has closer ties to the local region and local population.

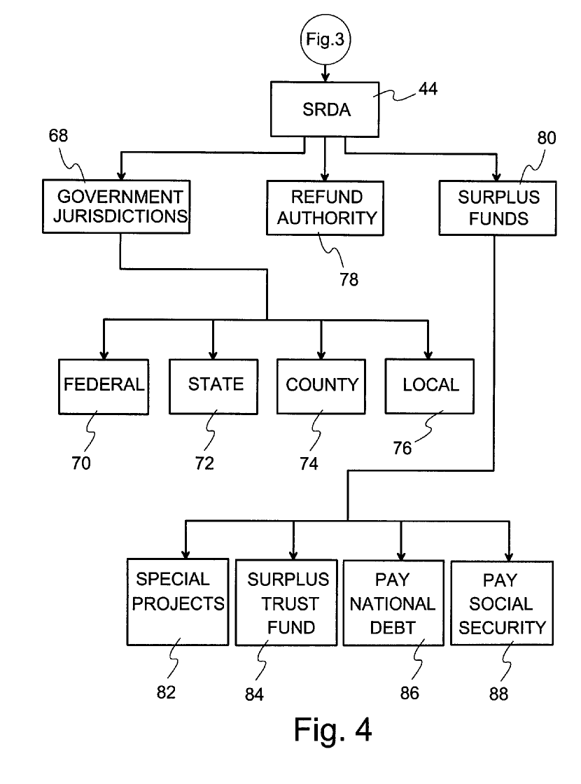

At the federal level, the government can maintain its existing tax agency, the Internal Revenue Service, to receive the federal share of taxes from the statewide SRDAs. Included tax jurisdictions within a state can maintain their existing tax departments, commissioners, and other administrative bodies to receive local shares of taxes. In FIG. 4, at block 44, a SRDA initially holds or controls available tax revenues collected by the banks within the state. Shares are disbursed to the other government jurisdictions at block 68. Funds are transferred to all jurisdictions in the area SRDA serves, from federal 70 to included jurisdictions such as state 72, county 74, and other local tax authorities 76.

The manner in which taxes are distributed can follow the scheme that established the tax rates to collect. Each tax jurisdiction may receive a fractional percent of amounts collected until the budget for the jurisdiction has been met. Using the gathered nexus data, SRDA initially can assign every amount collected to the lowest level area determined to be a source of the funds. The lowest level tax agency then distributes the funds upwardly to the various higher- level jurisdictions that have an interest in the collected percentage. This approach allows the low level agencies to continue their responsibility that began when they set the local tax rate to include the proportionate tax needs of all higher jurisdictions.

As previously mentioned, the refund authority may be an office of SRDA at block 78. The refund authority transfers collected tax money to all successful applicants for refund. These refund transactions take priority over disbursements to tax jurisdictions. To the extent SRDA distributes tax revenue to the lowest level tax jurisdictions, each refund is deducted from the account of the local jurisdiction where the tax was collected.

The tax system is expected to generate surplus funds. SRDA also administers surplus funds at block 80. Surplus funds constitute the extra tax money collected over the budget needs that were the basis for setting the tax rate. Surplus can be transferred to the lowest level agencies either for locally administered use or for disbursement to higher-level tax jurisdictions for their use. Some of the appropriate uses for surplus are special projects 82 such as local civic improvements; a trust fund 84 for future economic stimulus; payments on the national debt 86; or to bolster the social security system 88. These uses are merely suggested examples.

The performance of a tax system is important to all levels of government. A new system such as this money transfer tax system should be tested and proven before being widely relied upon. This system can be tested on a limited scale with a trial collection rate to establish and improve the necessary hardware and software for full implementation. A state or lower jurisdiction can best conduct a trial, using a nominal initial tax rate such as 0.1% to collect a minor part of the state's budget needs. The monetary value of tax collected will indicate what percent tax rate is needed for larger scale implementation and will allow evaluation of how efficiently the system operates. An indication that the system collects more or less than the expected tax will allow the proper rate to be established for larger scale use.

The tax system appears capable of generating surplus revenue above present budget levels without undue burden on the economy or on individual businesses. To the contrary, this tax system shows great promise that it will greatly relieve administrative toil for individuals, small businesses and large corporations alike. Governments can improve their services to the public when a surplus exists. If permitted by legislation, the tax system can be set to collect from 120% to 150% of budget need. The concept of collecting a surplus is distinguished from merely increasing budgets by a similar percentage. A surplus offers discretion in whether the funds will be spent and how the funds will be spent.

As the system is implemented, businesses can add the tax percentage to the price of products and services. The recommended way of increasing prices is by whole percentages, even when the tax is set in smaller fractions. This recommendation limits the complexity of setting prices by eliminating decimal or fractional calculations. The corresponding percentage to be deducted from deposits is then a slightly smaller percentage, as follows: for a 4% increase of all invoices, the corresponding transfer tax shall be 3.846%; for the 5% increase the corresponding tax is 4.761 %; and for a 6% increase in invoice amounts the corresponding tax is 5.66%. These corresponding tax rates provide for a net income that is equal to the invoice amount before the addition of the 4%, 5% or 6% that compensates for the tax deducted from the deposits. The uneven tax percentage deductions from the deposits do not pose any extra burden to computer driven calculations and record keeping by the tax collecting entities.

In a preferred implementation, networking computers are installed at all banks, check clearinghouses, and other fund transfer organizations to process money transactions and deduct tax. These computers are networked over secure connections to central accounting computers at central computer centers. The central computer centers might be located at the current regional Federal Reserve banks. The central computer centers calculate the respective percentages or sums of money to be received by each tax jurisdiction, administer the reduction of the national debt, and secure funding of the social security fund. All fund data and other economic data collected in the tax system that is not intrusive into the privacy of the individual can be made available to the public and posted on the Internet.

It can be expected that the creativity of many will seek loopholes for avoiding taxation under this proposed taxation scheme, such as settling accounts in jurisdictions outside the US or with stock transactions designed specially to avoid taxation. For example, offshore quasi-banking or accounting operations may offer a service of keeping money-equivalent book notations. Customers of such services might settle accounts between themselves by offsetting bookkeeping entries, thus seeking to avoid processing money through domestic banking channels. Enabling legislation and regulation can regulate and eliminate such attempts to avoid taxation and can be added to this transfer tax taxation scheme at any time when it is deemed appropriate. The overall aim should be for simplification even if marginal sources of taxation escape the general collection scheme. The remedies to close loopholes should not unduly harm the overall simplicity and should preferably be addressed with audit measures targeting the fringe areas of the taxation avoidance schemes.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A method of providing tax revenue to a tax jurisdiction, comprising:
first, determining a rate for taxation by periodically establishing a budget for the tax jurisdiction; predicting a value of monitorable money movement transactions having a nexus to the tax jurisdiction for the budget period; and setting a rate of taxation at least at the percentage of the predicted value of money transfer transactions needed to produce the budget;
second, collecting a tax by deducting the set tax rate percentage from the value of substantially all monitorable money movement transactions having a nexus to the tax jurisdiction; and
third, distributing the collected tax to the tax jurisdiction.

2. The method of claim 1, wherein the budget is a partial budget for the tax jurisdiction over the budget period.

3. The method of claim 1, wherein the budget is the entire budget for the tax jurisdiction over the budget period.

4. The method of claim 1, wherein a monitorable money movement transaction comprises moving money into a bank.

5. The method of claim 1, wherein a monitorable money movement transaction comprises the deposit of cash into a bank.

6. The method of claim 1, wherein a monitorable money movement transaction comprises the deposit of a check into a bank.

7. The method of claim 1, wherein a monitorable money movement transaction comprises cashing a check at a bank.

8. The method of claim 1, wherein a monitorable money movement transaction comprises an electronic transfer of funds into a bank.

9. The method of claim 1, wherein a monitorable money movement transaction comprises the deposit of a negotiable instrument into a bank.

10. The method of claim 1, wherein a monitorable money movement transaction comprises moving money out of a bank.

11. The method of claim 1, wherein a monitorable money movement transaction comprises moving money between at least two accounts within a bank.

12. The method of claim 1, wherein a bank performs said second step.

13. The method of claim 1, wherein a bank performs said third step.

14. A method of providing tax revenue to a tax jurisdiction, comprising:
first, determining a rate for taxation for the tax jurisdiction according to a percentage of the monetary value of money movement transactions having nexus to the tax jurisdiction;
second, collecting a tax on the value of a money movement transaction at the determined rate for taxation during bank processing of said money movement transaction; and
third, distributing the collected tax to the tax jurisdiction.

15. The method of claim 14, wherein said second step further comprises:
collecting tax on the monetary value of a money movement transaction being processed by a bank within said tax jurisdiction.

16. The method of claim 14, wherein said second step further comprises:
collecting tax on the monetary value of a money movement transaction being processed by a bank having a nexus to the tax jurisdiction.

17. The method of claim 14, wherein:
said second step further comprises, as a portion of said bank processing, collecting data indicative of the tax jurisdiction of a party to the money movement; and
said third step further comprises responding to said data by distributing at least a portion of the tax to the tax jurisdiction of said party.

18. The method of claim 17, further comprising: responding to said data by distributing at least a portion of the tax to a higher or lower tax jurisdiction of said party.

19. The method of claim 14, wherein:
said second step further comprises, as a portion of said bank processing, collecting data indicative of a preferred recipient of a donation by said party to the money movement; and
said third step further comprises responding to said data by distributing at least a portion of the tax to the preferred recipient.

20. The method of claim 14, wherein:
said second step further comprises, as a portion of said bank processing, collecting data indicative of a special handling applicable to the money movement transaction; and handling the money movement during the bank processing according to the indicated special handling.

21. The method of claim 14, wherein:
said second step further comprises, as a portion of said bank processing, collecting data indicative of an originating tax jurisdiction for a deducted tax amount.
